(19) United States
(12) Patent Application Publication
(10) Pub. No.: US 2002/0006362 A1
(43) Pub. Date: Jan. 17, 2002

(54) Sample assaying apparatus

(75) Inventors: Masato Ohta, Shizuoka (JP); Shogo Kida, Shizuoka (JP); Yasuhiko Yokomori, Shizuoka (JP)

Correspondence Address: GREENBLUM & BERNSTEIN, P.L.C., 1941 ROLAND CLARKE PLACE, RESTON, VA, 20191, US

(73) Assignee: SUZUKI MOTOR CORPORATION, Shizuoka (JP)

(21) Appl. No.: 09/893,668

(22) Filed: Jun. 29, 2001

(30) Foreign Application Priority Data
Jul. 13, 2000 (JP) 2000-212363

(51) Int. Cl. B01L 3/02

(52) U.S. Cl. 422/102; 422/100

(57) ABSTRACT

The present invention aims at providing a small-sized assaying apparatus having multiple functions such as dispensing function and heating function.

The apparatus comprises: a reagent/sample tray 20 capable of moving reciprocally on a base 11; a tray conveying mechanism 30 for conveying the reagent/sample tray 20 reciprocally; a dispensing mechanism 40 for dispensing the sample or the reagent into each reaction well; and a temperature maintaining mechanism 50 for maintaining the temperature of the microplate at a predetermined temperature,

wherein the dispensing mechanism 40 has a dispenser 41 for dispensing the sample and the reagent and a carrier 90 for carrying the dispenser 41 in a direction perpendicular to the reciprocating direction of the reagent/sample tray; a supporter 28 for the microplate is provided at the end of the reagent/sample tray 20 in the direction perpendicular to the reciprocating direction of the reagent/sample tray 20; and the temperature maintaining mechanism 50 is arranged adjacent to the supporter 28—provided side of the reciprocating region of the reagent/sample tray 20.

### FIELD OF THE INVENTION

The present invention relates to a sample assaying apparatus. More particularly, the present invention relates to a sample assaying apparatus preferable for a reaction assay between a sample and a reagent, such as an enzyme immunoassay.

### BACKGROUND OF THE INVENTION

A sample reaction assay as a clinical test in the medical art, such as an enzyme immunoassay, is conducted as follows. First, samples are dispensed into reaction vessels, into which a reagent is poured. While maintaining at a predetermined temperature (if necessary), the samples and the reagent are shaked to equalize the reaction conditions. Thereafter, the reactions characteristic of the reagent are observed. Other than these steps, the samples or the reagent may be diluted, or a new reagent may be added during these steps, or the vessels may be washed.

Accordingly, the reaction assay often requires various complicated steps, troubling the inspector in charge of the assay, especially when the assay is carried out for more number of samples. As a result, recently, automation of the above-described steps is undergoing development.

The above-described various steps are preferably carried out continuously without being interrupted. In addition, some of the steps may be repeated by turns. Thus, a single assaying apparatus, which can perform a plurality of steps of the above-described steps, is demanded.

However, this requires mechanisms for performing the respective steps, as well as a transferring unit for transferring the reaction vessels containing the samples across these mechanisms, which results in a problem of a very large apparatus. Thus, it has been important to solve this problem.

Furthermore, if the above-described diluting step should also be performed by the assaying apparatus, shaking of the samples and the reagents, and shaking of the samples and/or the reagents and a diluent are both necessary. Performing both of the shaking with a single shaking unit extends the time required for the assay. If two shaking units are employed for the respective shaking, the size of the apparatus will undesirably become larger.

The present invention improves the above-described inconveniences of the conventional apparatus, and has an objective of providing a small-sized sample assaying apparatus, which can perform a plurality of steps necessary for a reaction assay between a sample and a reagent in a short time.

### SUMMARY OF THE INVENTION

The present invention is a sample assaying apparatus for performing a reaction assay for a sample by using a microplate having a plurality of reaction vessels thereon in which the sample and a reagent are subjected to reaction, the apparatus comprising: a reagent/sample tray for mounting a plurality of containers individually containing the reagent or the sample; a base for supporting the reagent/sample tray such that the tray is capable of moving reciprocally; a tray conveying mechanism for conveying the reagent/sample tray reciprocally; a dispensing mechanism for dispensing the sample or the reagent into each reaction vessel of the microplate; and a temperature maintaining mechanism for maintaining the temperature of the microplate at a predetermined temperature.

The dispensing mechanism has a dispenser for dispensing the sample or the reagent and a conveyer for conveying the dispenser in a direction perpendicular to the reciprocating direction of the reagent/sample tray.

Furthermore, a supporter for the microplate is provided at the end of the direction perpendicular to the reciprocating direction of the reagent/sample tray, and the temperature maintaining mechanism is arranged adjacent to the supporter-provided side of the reciprocating region of the reagent/sample tray.

According to the above-mentioned structure, the samples on the reagent/sample tray are carried to the dispensing mechanism by the tray conveying mechanism, where a sample is sucked by the dispenser of the dispensing mechanism. Then, the dispenser is aligned with a predetermined reaction vessel of the microplate via the cooperation of the conveyer of the dispensing mechanism and the tray conveying mechanism, whereby the sucked sample is discharged. This dispensing operation is repeated for each reaction vessel depending on the number of the samples.

Similarly, the reagent on the reagent/sample tray is dispensed into the reaction vessels.

Once the samples and the reagent are dispensed, the microplate on the reagent/sample tray is carried to the temperature maintaining mechanism by the tray conveying mechanism, where the microplate is maintained at a predetermined temperature for a predetermined period of time. As a result, the reactions are promoted. If another reagent needs to be added, the reagent/sample tray is carried by the tray conveying mechanism to be dispensed with another reagent.

In this manner, the reagents and the samples are dispensed into the microplate and the reaction is promoted by maintaining the microplate at the predetermined temperature.

Moreover, the conveyer of the dispensing mechanism conveys the dispenser in a direction perpendicular to the reciprocating direction of the reagent/sample tray. In this case, the dispensing mechanism is positioned with respect to each reaction vessel upon dispensing the samples and the reagent by the cooperation of the reciprocating movement of the reagent/sample tray and the reciprocating movement of the dispenser.

Moreover, a washing mechanism for washing inside each of the reaction vessels of the microplate, wherein the washing mechanism is arranged adjacent to the supporter-provided side of the reciprocating region of the reagent/sample tray.

According to this structure, the microplate is carried to the washing mechanism between or after the above-described operations, where the reaction vessels are washed. Since the washing mechanism is adjacent to the microplate-supporter side of the translation region of the reagent/sample tray, the microplate held by the supporter can be aligned with the washing mechanism by moving the reagent/sample tray.

Moreover, the sample assaying apparatus has a photometer for determining the reaction within each of the reaction vessels of the microplate, wherein the photometer is arranged adjacent to the supporter-provided side of the reciprocating region of the reagent/sample tray.

According to this structure, the reagent is dispensed into the microplate to determine the reaction. Since the determining mechanism is adjacent to the microplate-supporter side of the translation region of the reagent/sample tray, the microplate held by the supporter can be aligned with the determining mechanism by moving the reagent/sample tray. The results of the measurement is either output to an external output device or stored in a memory provided in the sample assaying apparatus.

Moreover, the supporter of the microplate protrudes from the end of the reagent/sample tray in the direction perpendicular to the reciprocating direction of the reagent/sample tray; the temperature maintaining mechanism has a temperature adjuster and a housing for accommodating the temperature adjuster and is arranged to overlap the translation region of the microplate and the supporter; and the housing is provided with a notch where it overlaps with the translation region of the microplate and the supporter.

According to this structure, part of the housing is notched. Therefore, the microplate can be carried inside the housing to perform the heating operation.

Moreover, the supporter of the microplate is formed as a frame so as to hold the microplate with the top and back surfaces thereof being exposed; the temperature adjuster of the temperature maintaining mechanism faces the back surface of the microplate held by the supporter; and the housing has a lid for covering the top surface of the microplate.

According to this structure, the microplate is carried between the heater and the lid of the temperature maintaining mechanism for the heating operation.

Moreover, the sample assaying apparatus has a vibrating mechanism on the reagent/sample tray, for shaking the microplate held on the supporter.

According to this structure, the microplate is shaken after dispensing the sample or the reagent into the microplate or after heating the microplate, to shake the sample and the reagent.

Moreover, the sample assaying apparatus has a region on the supporter for arranging the microplate for reacting the sample and the reagent and for arranging a microplate for performing dilution.

The microplate for performing dilution may have the same structure as that of the reaction microplate. In this case, the subject to be diluted (sample or reagent) is dispensed into the dilution microplate in the same manner as for the reaction microplate, and then diluent is dispensed into each well, thereby performing the dilution operation. The diluent may be pre-arranged on the reagent/sample tray.

After performing the dispensing operations for the reaction microplate and the dilution microplate on the supporter, the microplates are shaken together via the supporter by the vibrating mechanism to shake the contents in the wells. Other operation is the same as the above invention.

By the above-described structures, the present invention aims at achieving the above-described objective.

### BRIEF DESCRIPTION OF THE DRAWINGS

FIG. 1 is a schematic perspective view showing an arrangement of parts constituting an enzyme immunoreaction assaying apparatus according to one embodiment;

FIG. 2 is a schematic plan view showing the arrangement of parts constituting the enzyme immunoreaction assaying apparatus;

FIGS. 3A and 3B are a plan view and a cross-sectional view (front view) of an assay plate used in the enzyme immunoreaction assaying apparatus, respectively;

FIG. 4 is a perspective view of a reagent/sample tray in use;

FIGS. 5A and 5B are a plan view and a cross-sectional view of a support frame, respectively;

FIG. 6 is an exploded perspective view of a vibrating mechanism;

FIG. 7 is a plan view of a stage unit;

FIG. 8 is a perspective view of a housing with its lid being opened;

FIG. 9 is a perspective view showing the relationship of the translation region of the assay plate/support frame with the notch in the housing of the temperature maintaining mechanism;

FIGS. 10A and 10B are a front view and a side view of a photometer, respectively;

FIG. 11 is a front view of a washing mechanism;

FIG. 12 a is a partial left side view of the washing mechanism;

FIG. 13 is a plan view of a conveyer of the dispensing mechanism;

FIG. 14 is a front view of a dispenser of the dispensing mechanism;

FIGS. 15A and 15B are illustrations showing attachment of tips to the tip of the dispenser, where

FIG. 15A shows the attachment of a sample tip and

FIG. 15B shows the attachment of a reagent tip;

FIGS. 16A and 16B are a perspective view and a front view of a tip disposing unit, respectively;

FIG. 17 is an illustration showing the relationship between a plate cover and the assay plate supported by the support frame;

FIG. 18 is a perspective view of the plate cover; and

FIG. 19 is a flowchart sequentially showing the operations of the enzyme immunoreaction assaying apparatus.

### DETAILED DESCRIPTION OF THE INVENTION

(General Structure of Embodiment of the Invention)

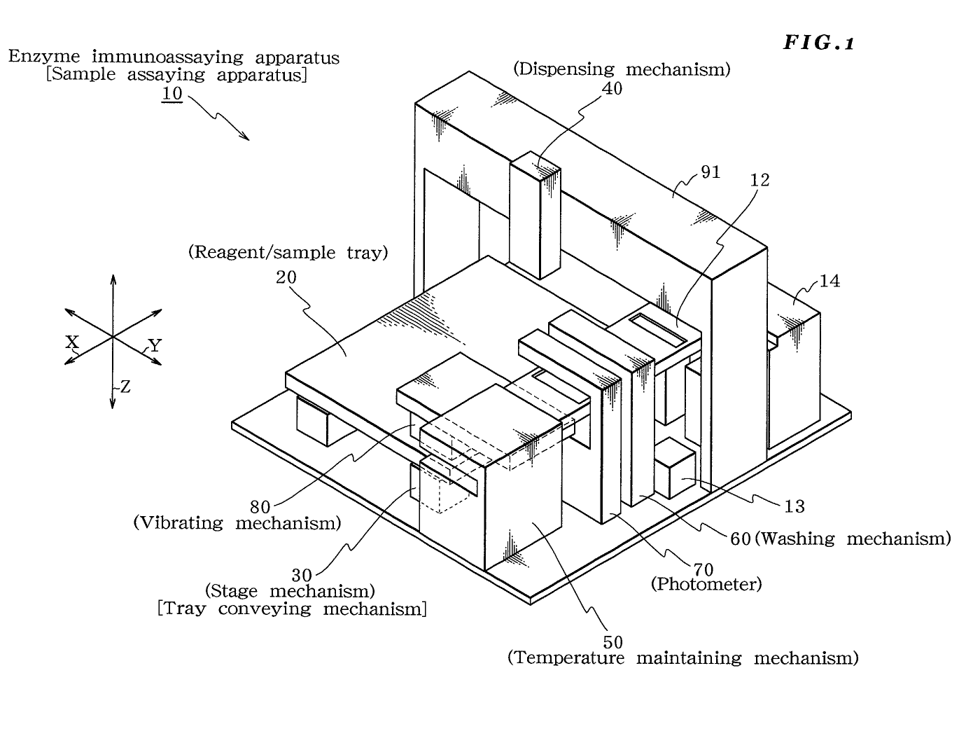

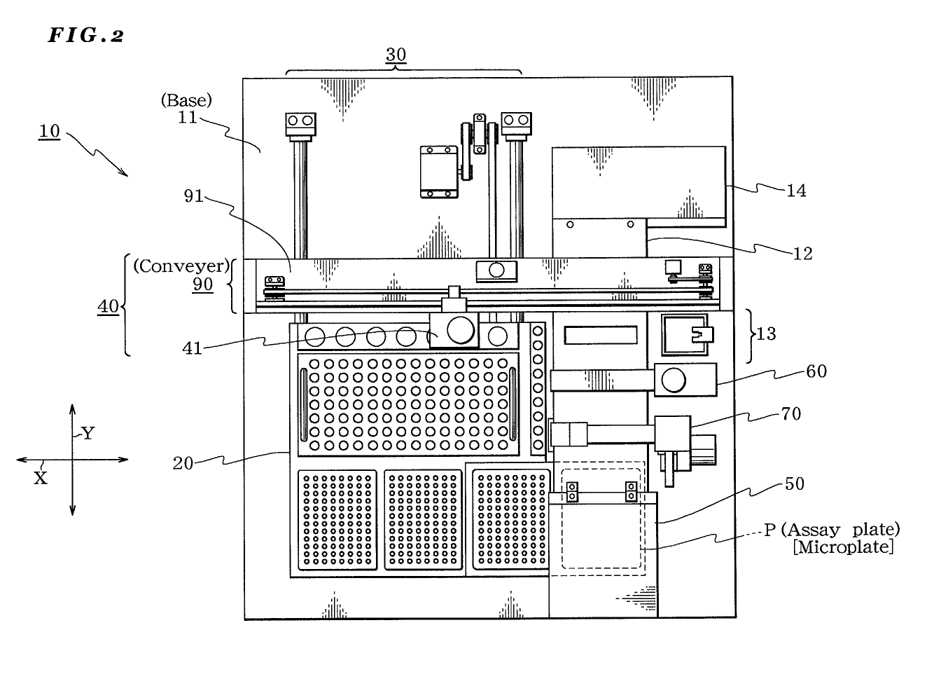

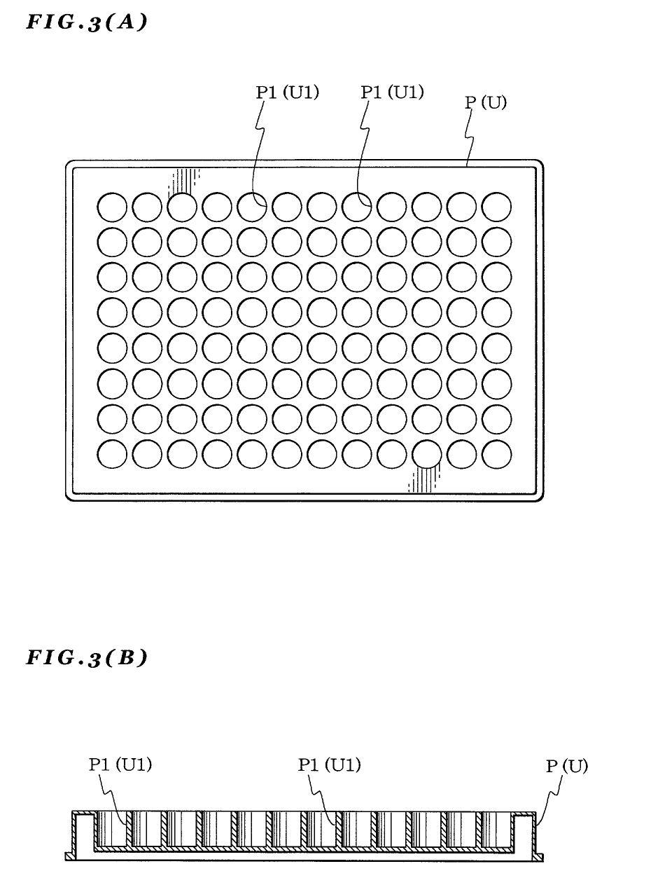

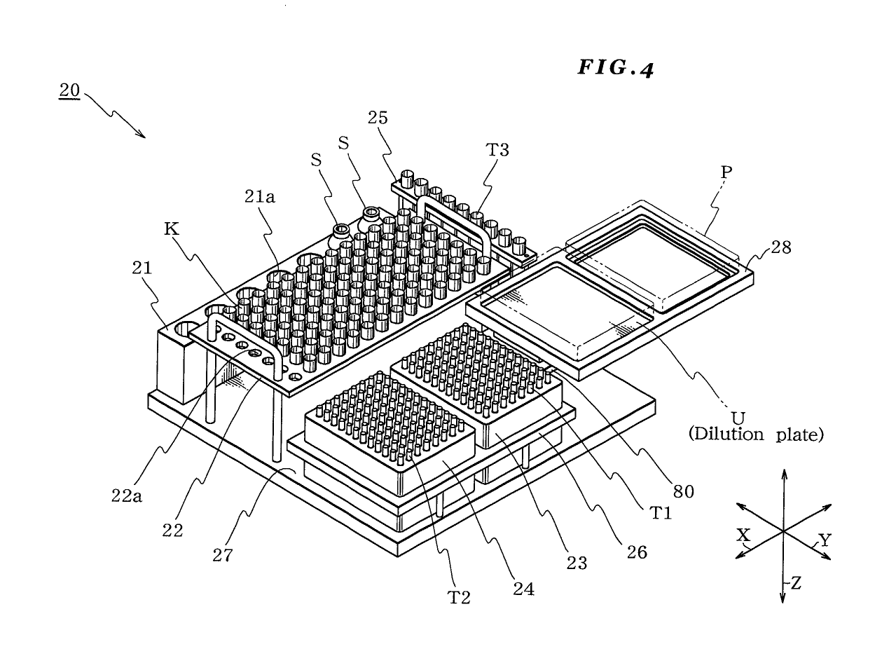

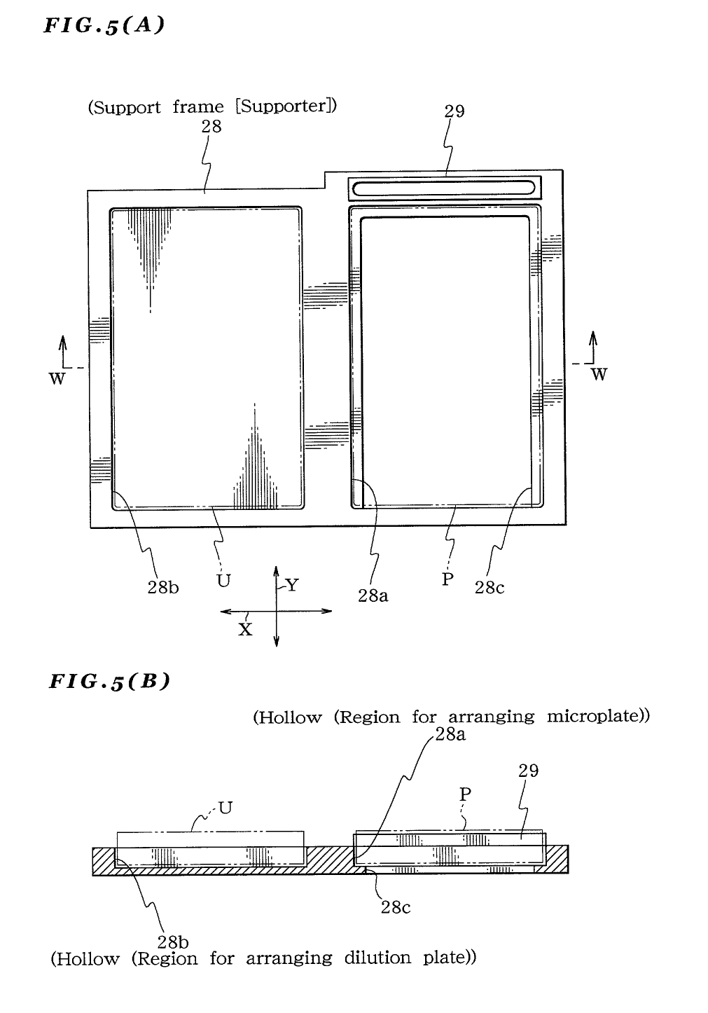

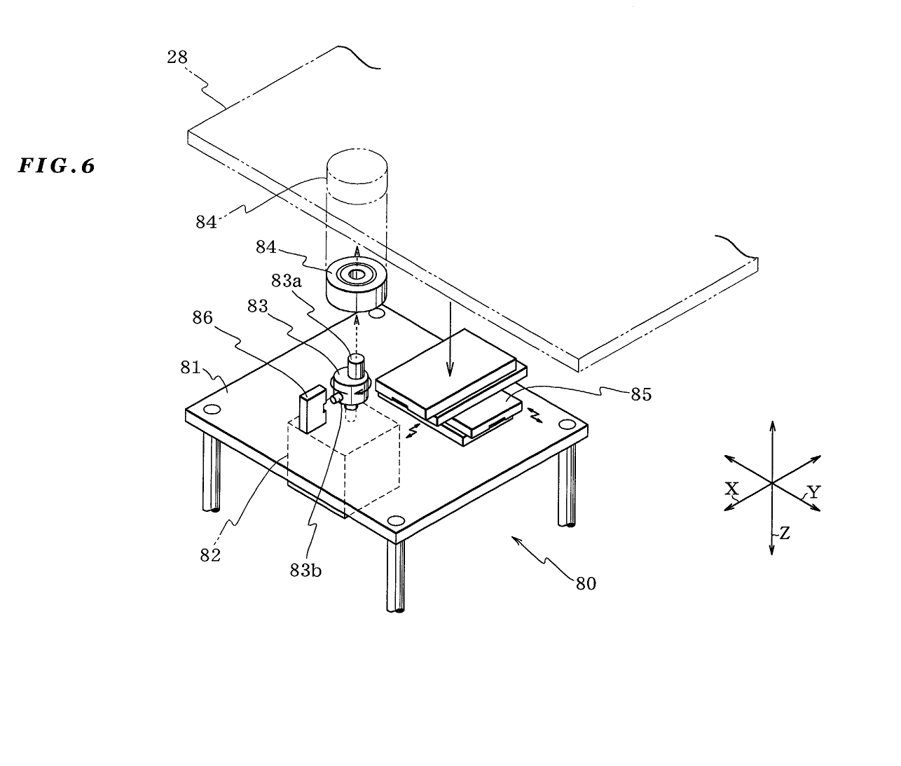

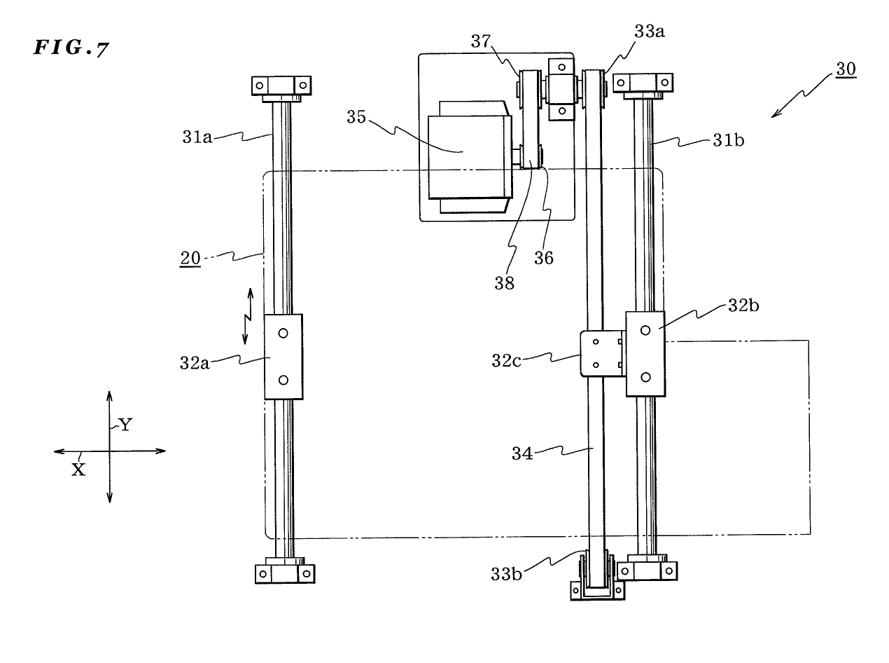

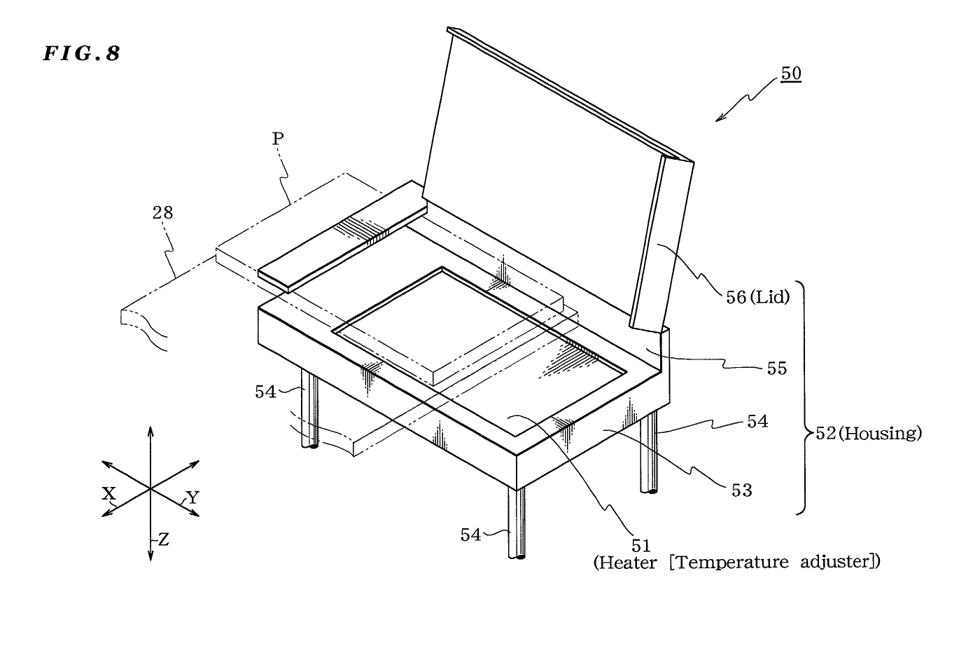

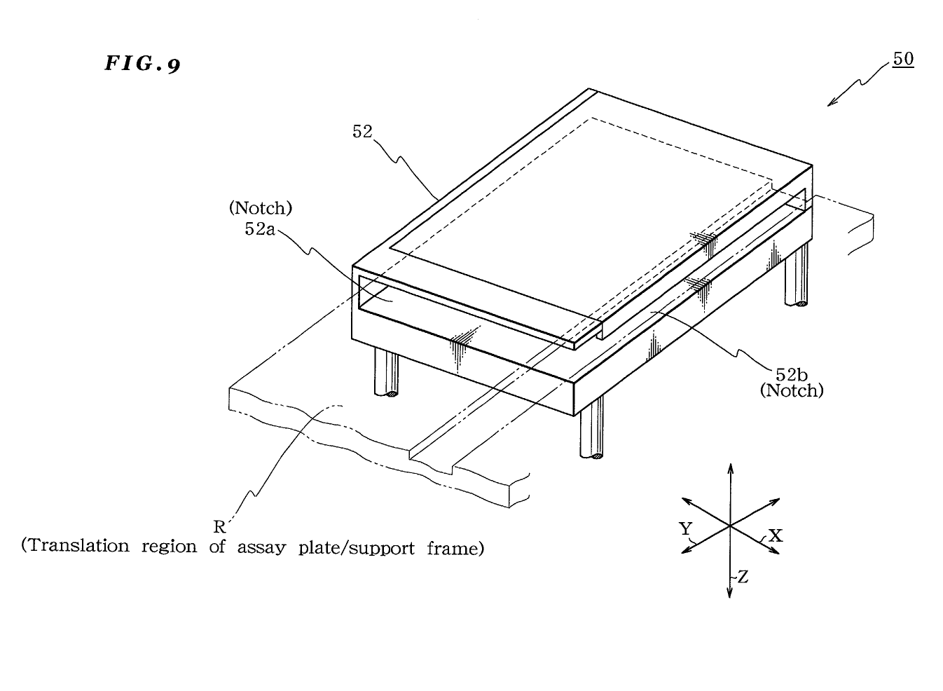

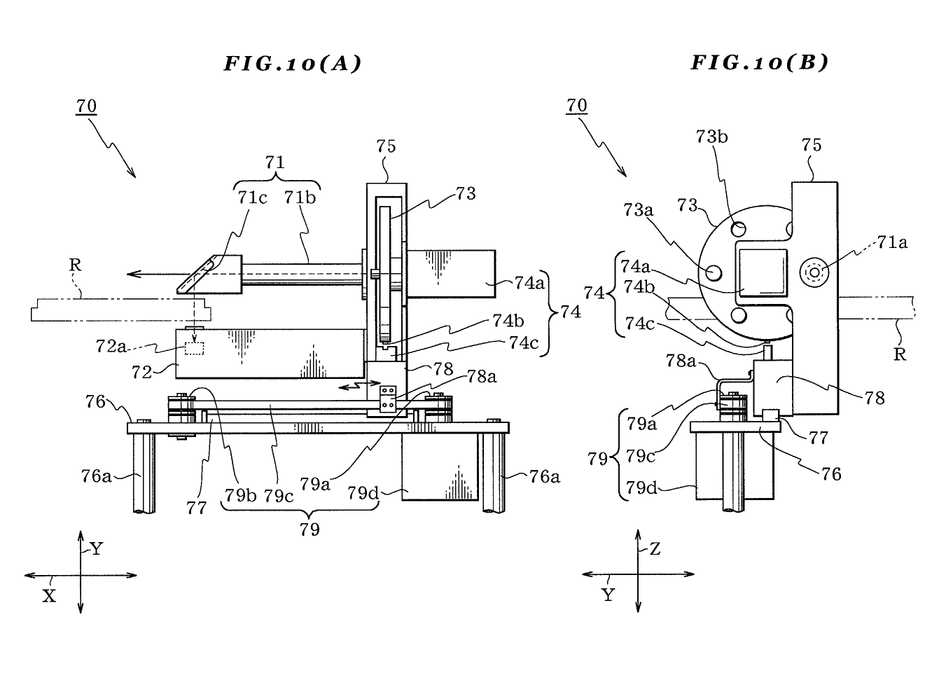

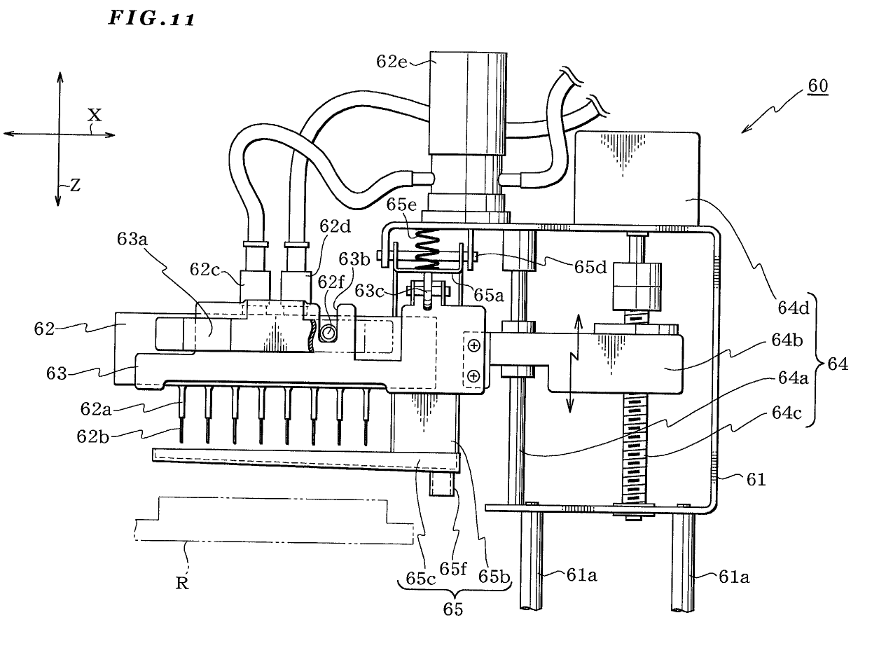

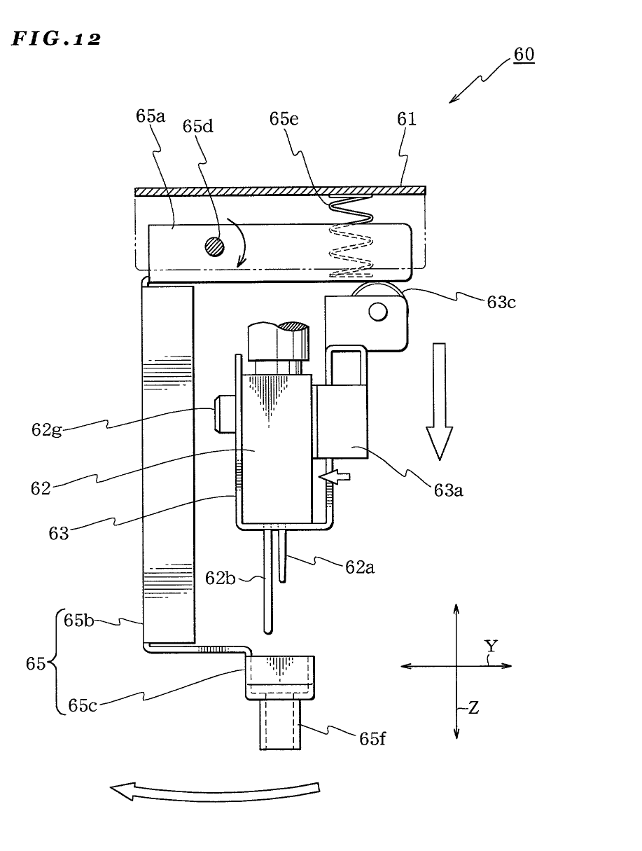

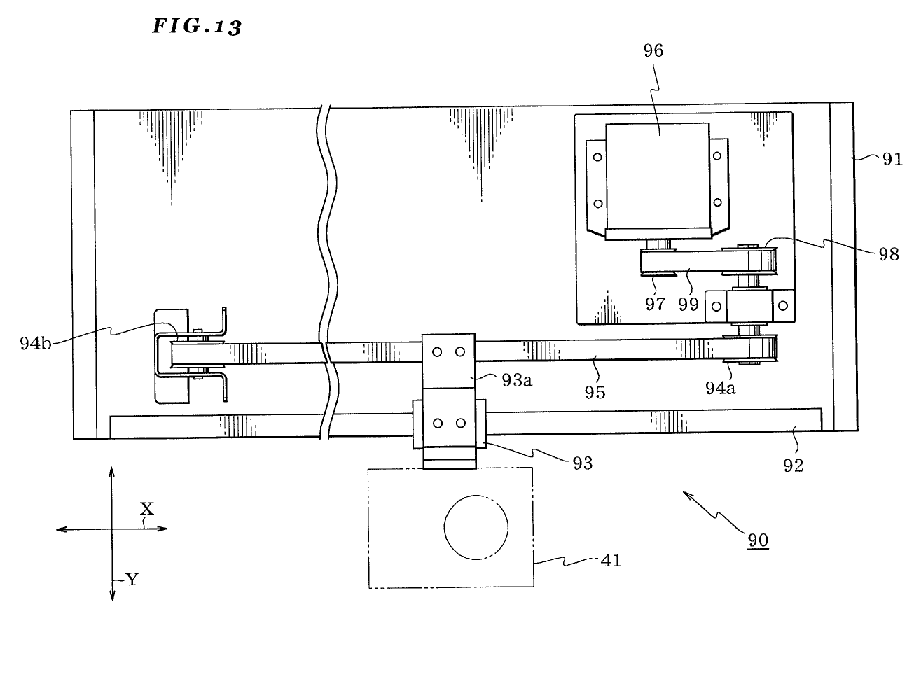

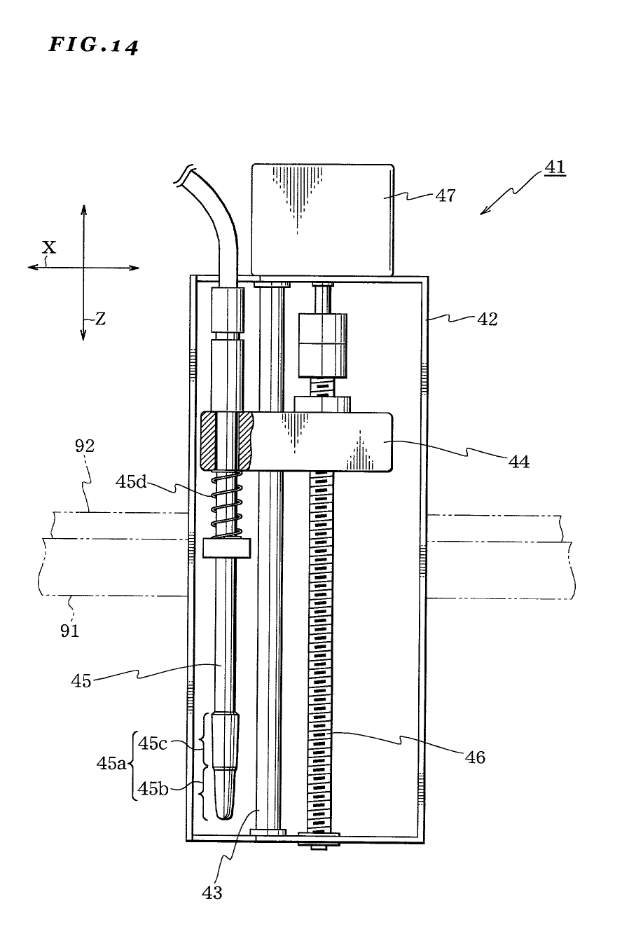

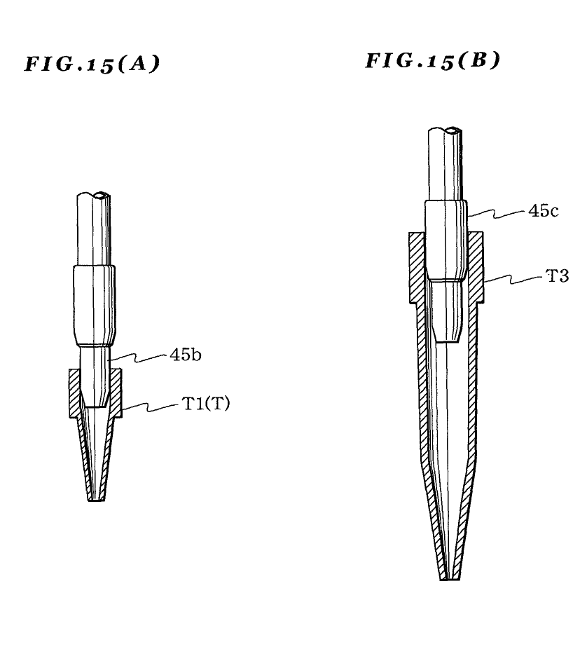

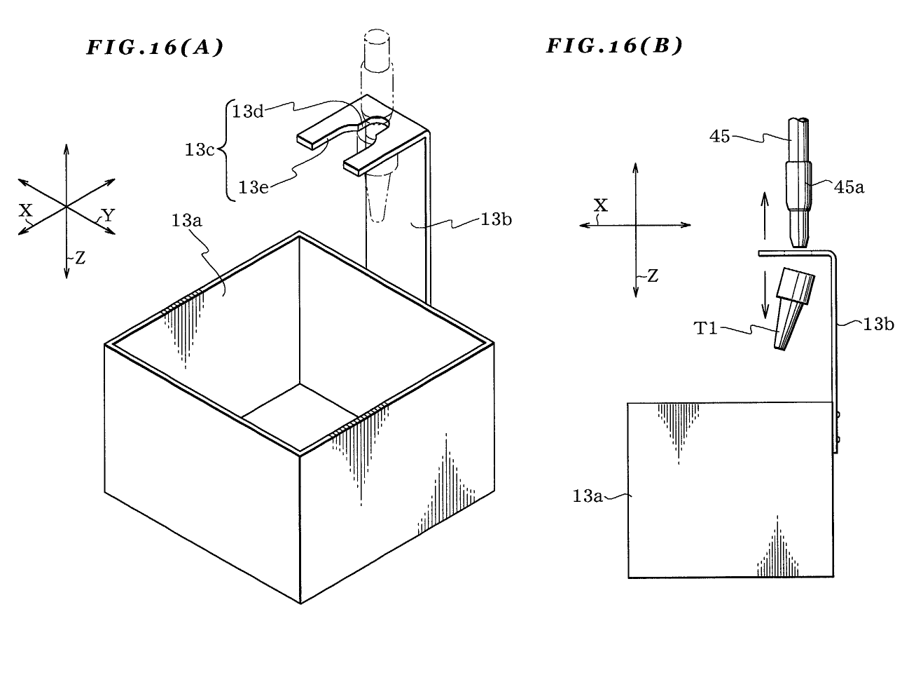

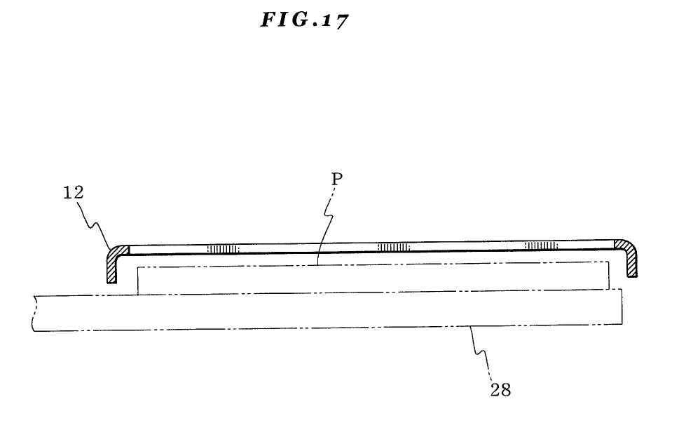

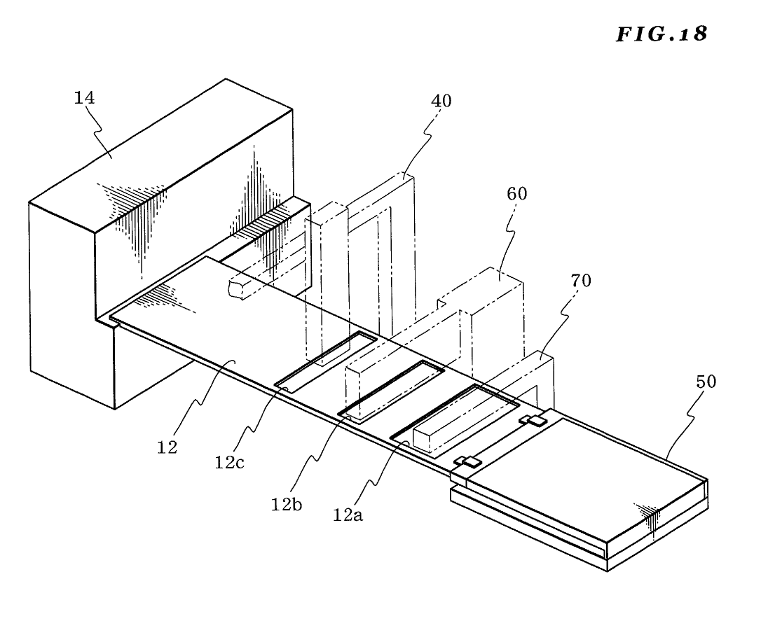

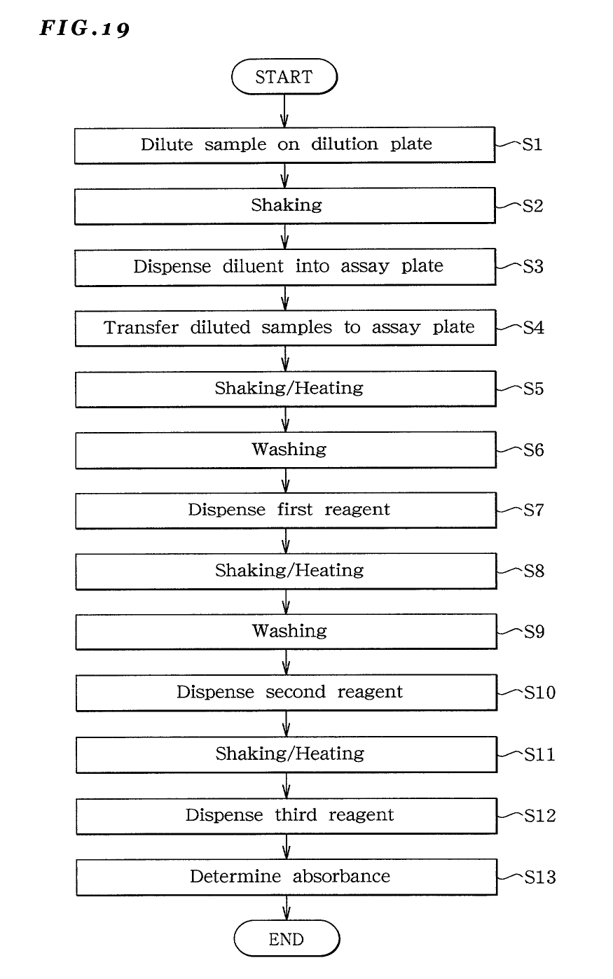

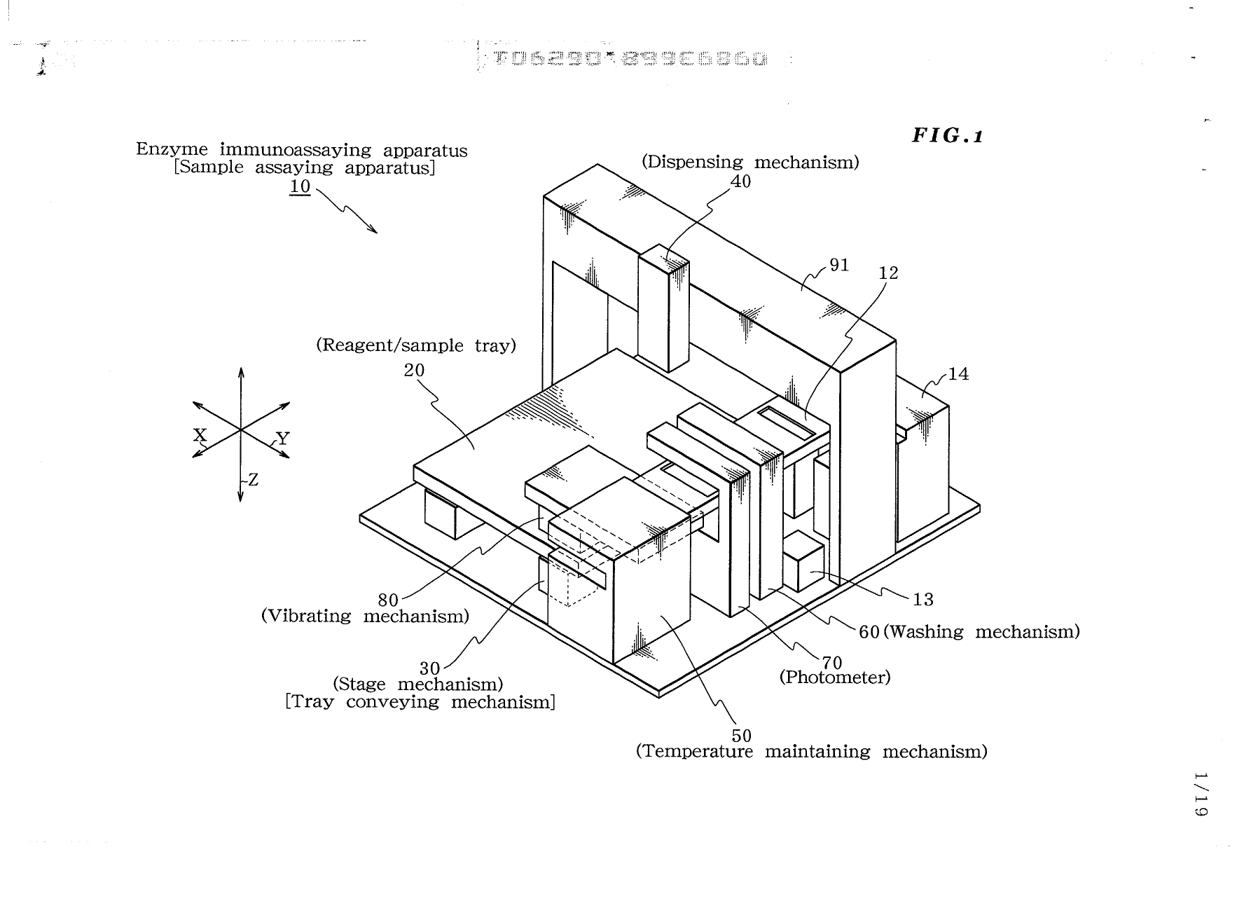

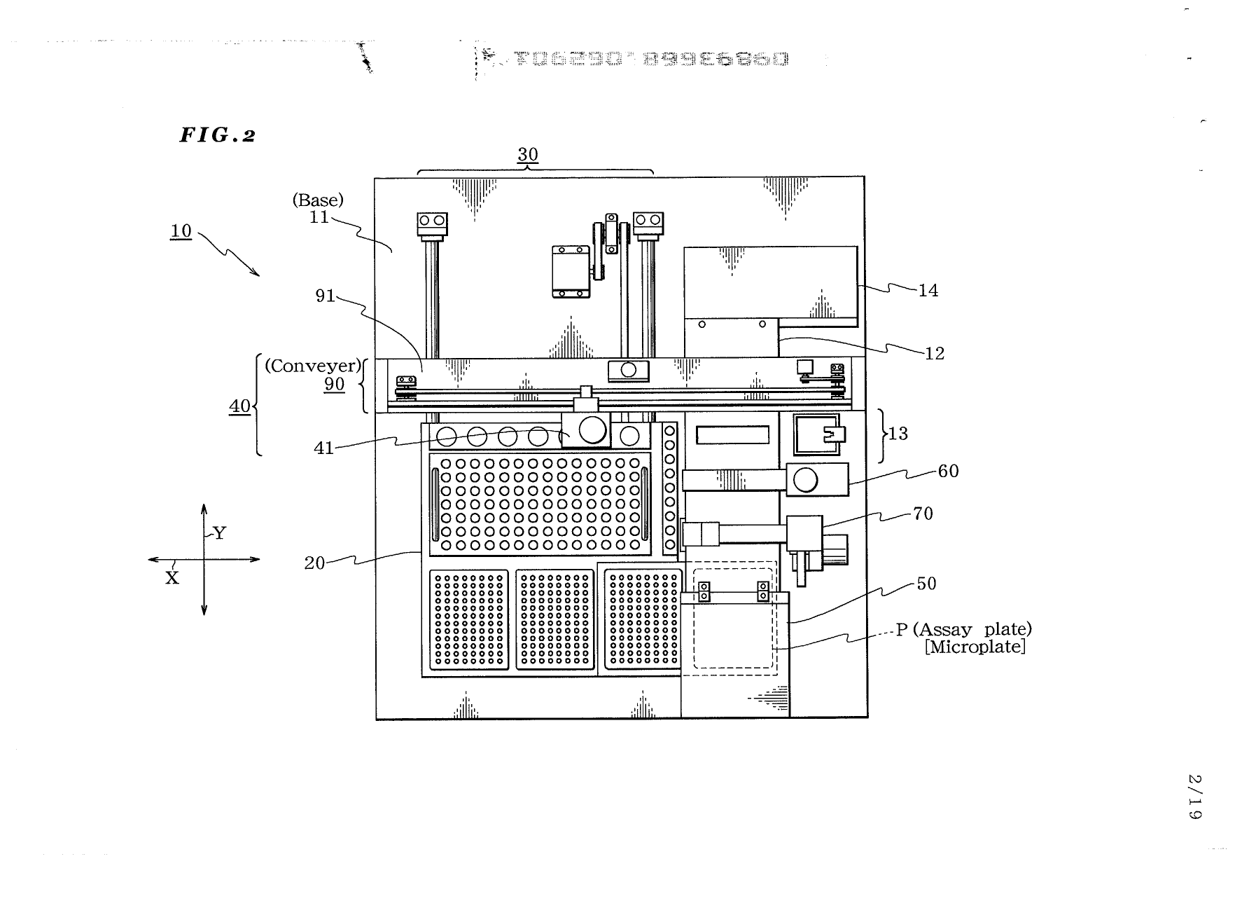

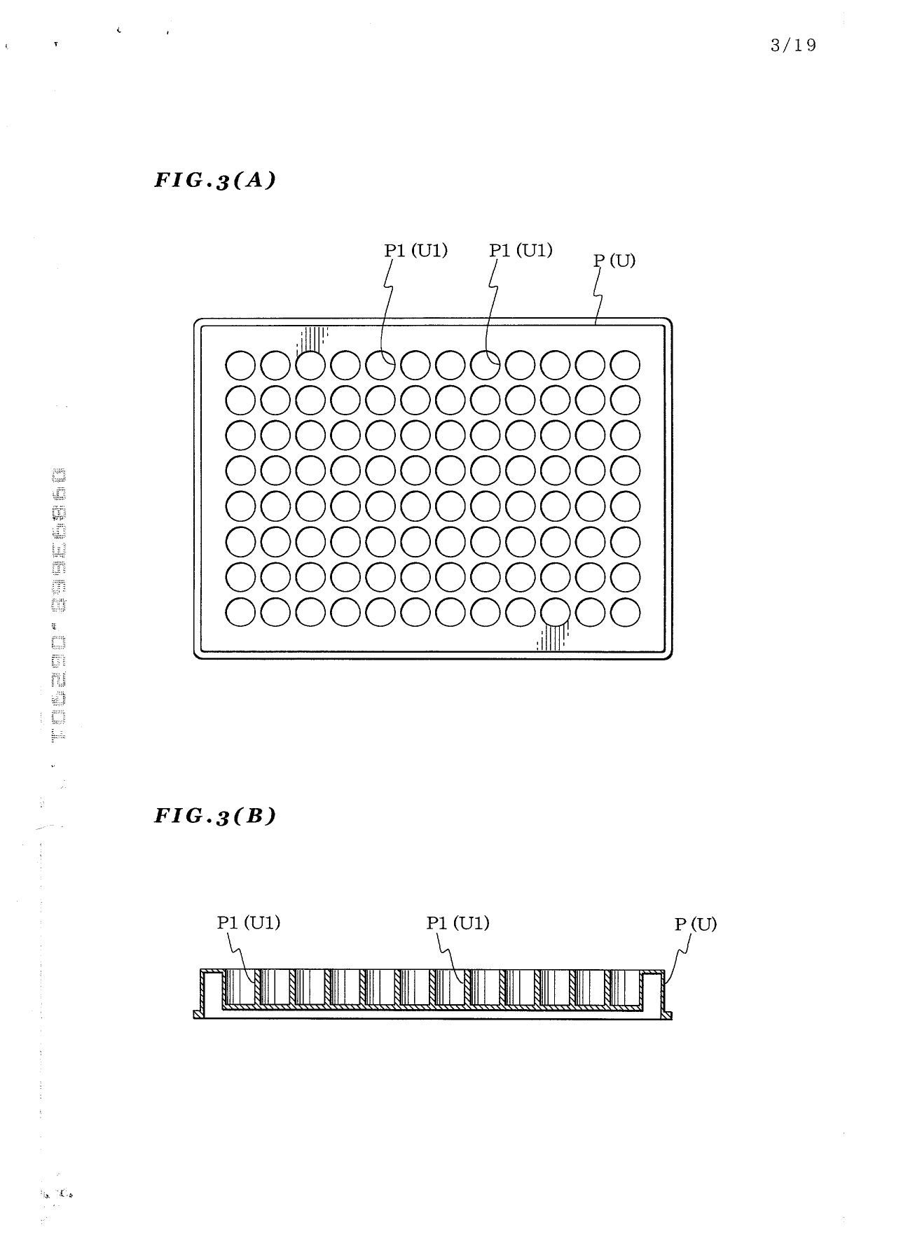

Hereinafter, one embodiment of the present invention will be described with reference to FIGS. 1 to 19. The present embodiment is an enzyme immunoassaying apparatus 10 which is a sample assaying apparatus for testing an antibody reaction for body fluids, blood, serum or the like from a subject. For this assay, an assay microplate (hereinafter, referred to as an assay plate P) is used which has a plurality of wells P1 (see FIG. 3) as reaction vessels where enzyme immunoreactions between a sample and reagents take place. FIG. 1 is a schematic perspective view showing an arrangement of assembled parts of the enzyme immunoassaying apparatus 10. FIG. 2 is a schematic plan view also showing the arrangement of the assembled parts of the enzyme immunoassaying apparatus 10.

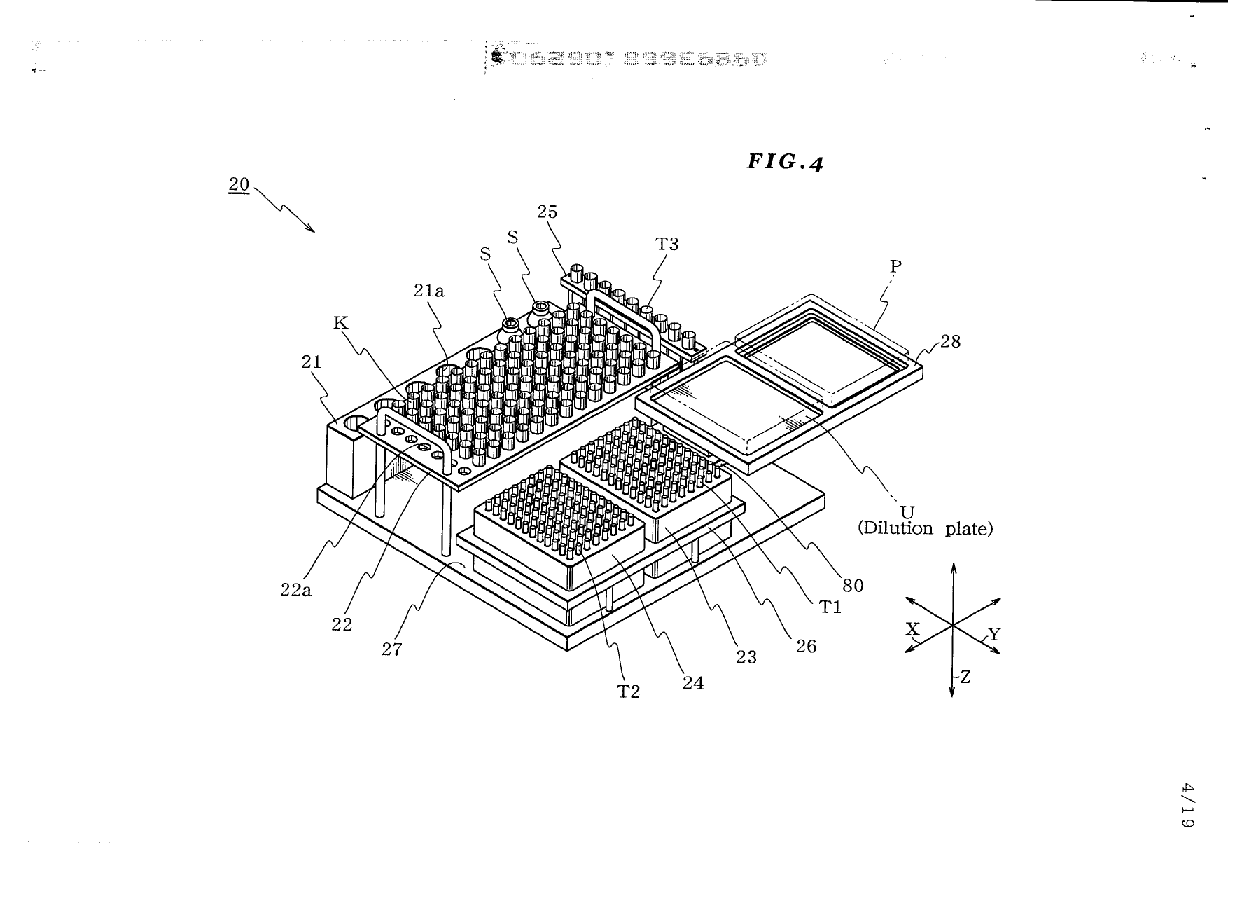

The enzyme immunoassaying apparatus 10 is provided with: a reagent/sample tray 20 for mounting a plurality of reagent bottles S containing different types of reagents and a plurality of sample containers K (see FIG. 4) containing different samples; a base 11 for supporting the reagent/sample tray 20 such that the tray 20 is capable of moving reciprocally; a stage mechanism 30 for conveying the reagent/sample tray 20 reciprocally; a dispensing mechanism 40 for dispensing the sample or the reagent into each well P1 of the assay plate P; a temperature maintaining mechanism 50 for maintaining the temperature of the assay plate P at a predetermined temperature; a washing mechanism 60 for washing inside each well P1 of the assay plate P; a photometer 70 for determining an enzyme immunoreaction in each well P1 of the assay plate P; a plate cover 12 for preventing the sample or the reagent in each well P1 of the assay plate P from drying; and a tip disposing unit 13 for disposing later-described disposable tips T1, T2 and T3. The reference numeral 14 denotes a power source for supplying electric power to each part of the apparatus. The enzyme immunoassaying apparatus 10 is connected to a personal computer (not shown) as a unit for controlling the operation of each part of the apparatus.

Hereinafter, details of each part will be described.

(Assay Plate and Dilution Plate)

First, the assay plate P will be described before describing the structures of other parts. A microplate for diluting the later-described samples or reagents (hereinafter, referred to as a dilution plate U) will also be described here since it has the same structure as that of the assay plate P. FIGS. 3A and 3B are a plan view and a cross-sectional view (front view) of an example of the assay plate P (the dilution plate U), respectively. A total of 96 (12 in width×8 in length) wells P1 (U1) are arranged on the surface of the assay plate P (the dilution plate U). Each well P1 (U1) has a flat bottom and an open top. The wells of the assay plate P (dilution plate U) are not limited to flat bottoms, and may have semi-spherical bottoms.

The assay plate P is made of transparent plastic so that when a light beam of a predetermined wavelength is radiated from above, absorbance can be determined based on the beam transmitted through the assay plate P, thereby obtaining measurements of the enzyme immunoreactions. The entire inner surface of each well P1 is applied with a reagent in advance, into which the sample or other reagent may be dispensed. The dilution plate U is not necessarily transparent and no reagent is applied thereto.

(Base)

The base 11 is a plate-like member on which the above-mentioned parts of the enzyme immunoassaying apparatus 10 are mounted. The base 11 and other parts are all accommodated in an apparatus case (not shown).

(Reagent/Sample Tray)

Next, the reagent/sample tray 20 will be described with reference to FIGS. 2 and 4. FIG. 4 is a perspective view of the reagent/sample tray 20 in use. The reagent/sample tray 20 is mounted on the base 11 via the tray conveying mechanism 30. The reagent/sample tray 20 is provided with a rectangular tray board 27 and a group of stock units arranged on the tray board 27.

The group of stock units on the tray board 27 is arranged in order in the Y-direction, the direction along which the tray conveying mechanism 30 moves reciprocally. Specifically, the stock units include a reagent stock unit 21 for holding the reagent bottles S containing the different types of reagents appropriate for the assay system, a sample stock unit 22 for holding the plurality of sample containers K containing individual samples, a sample tips stock unit 23 for holding a plurality of sample tips T1 used for dispensing each sample into a corresponding well P1 of the assay plate P, a diluent tips stock unit 24 for holding a plurality of diluent tips T2 corresponding to respective wells P1, and a reagent tips stock unit 25 adjacent to the reagent stock unit 21 and the sample stock unit 22, for holding reagent tips T3 for dispensing the corresponding reagents.

The reagent stock unit 21 has seven sockets 21a lined in the X-direction (direction perpendicular to the above-mentioned Y-direction) for receiving the reagent bottles S. The number of the sockets, however, is not limited thereto and may be increased or reduced at need.

The sample stock unit 22 is formed as a tray, and is detachable from the tray board 27. The sample stock unit 22 has a total of 98 (14 in X-direction×7 in Y-direction) sockets 22a where the sample containers with closed bottoms and open tops are inserted and held. The total number of the sockets 22a is also not limited thereto.

The sample tips stock unit 23 and the diluent tips stock unit 24 are arranged adjacent to each other in the X-direction. Both of the stock units are adjacent to the sample stock unit 22. Each of the tips stock units 23 and 24 is detachably held on a holder 26 mounted on the tray board 27. The tips stock units 23 and 24 have the same structures. The sample tip T1 and the diluent tip T2 have the same structures as well. The tips T1 and T2 are detachably held in the tips stock units 23 and 24, respectively.

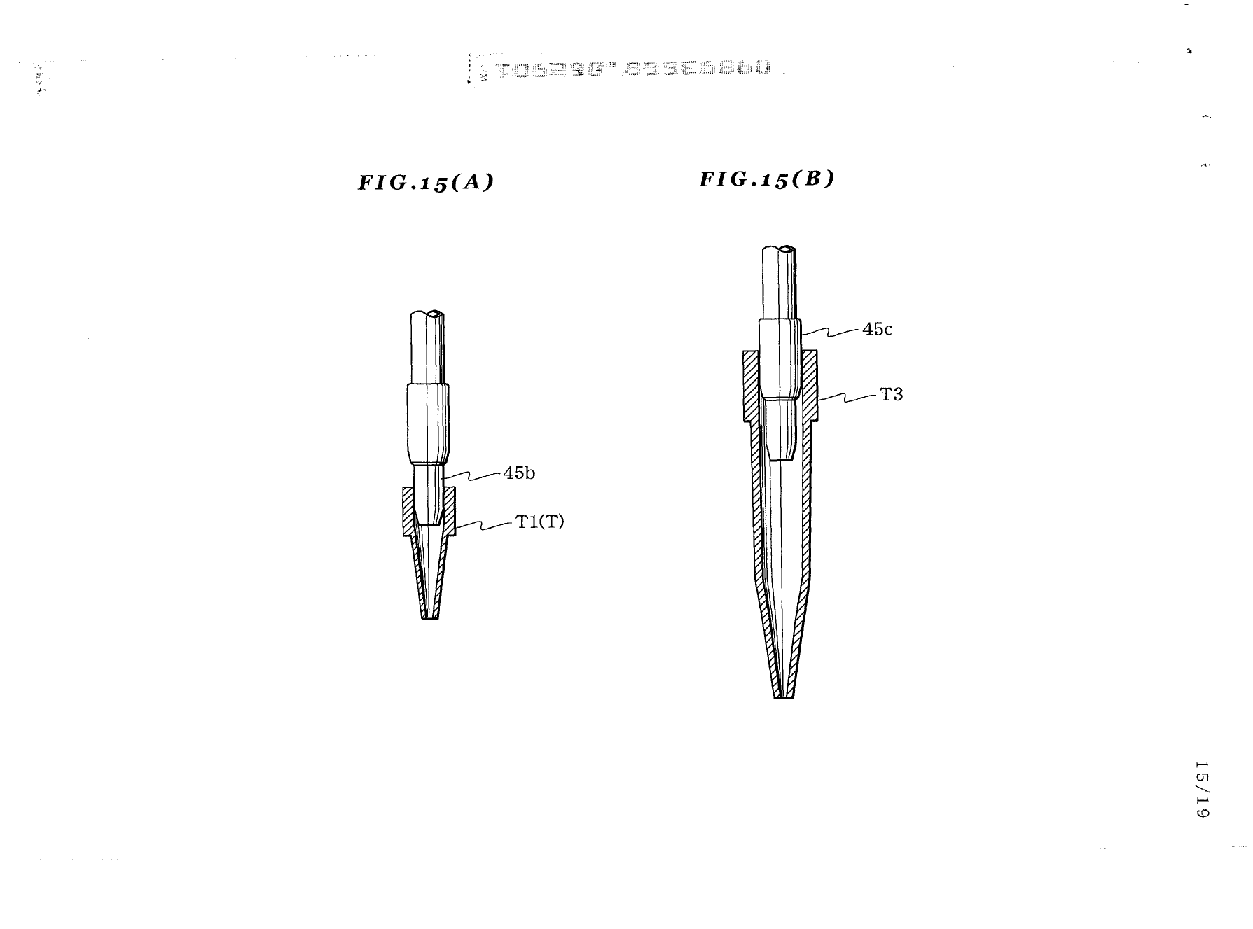

To be more specific, each of the tips T1 and T2 is a tube with a tapered end (see FIG. 15A). The root of the tip T1 or T2 is attached to the tip of a dispensing nozzle of the later-described dispensing mechanism 40 in order to suck and discharge the sample or the diluent via the tapered end of the tip. In order to prevent the individual samples from mixing with each other, each of the tips T1 and T2 are individually provided for each well P1 or U1 of the assay plate P or the dilution plate U.

The above-described reagent tips stock unit 25 is provided at one end of the tray board 27 in the X-direction. The reagent tips stock unit 25 can hold nine reagent tips T3 in the Y-direction. Each of the tips T3 is detachable from the tips stock unit 25. The number of tips to be held is not limited, but preferably higher than the number of the reagent bottles held in the reagent stock unit 21.

To be more specific, each of the reagent tips T3 is a tube with a tapered end similar to the above-described sample tips T1 (see FIG. 15B). Similarly, the root of the tip T3 is attached to the tip of the dispensing nozzle of the later-described dispensing mechanism 40 in order to suck and discharge the reagent via the tapered end of the tip. The reagent tips T3 have a larger diameter and a longer length than the sample tips T1, and thus can contain for a greater volume. The reagent tips T3 are individually provided for the respective reagent bottles S in order to prevent the reagents from mixing with each other.

(Support Frame)

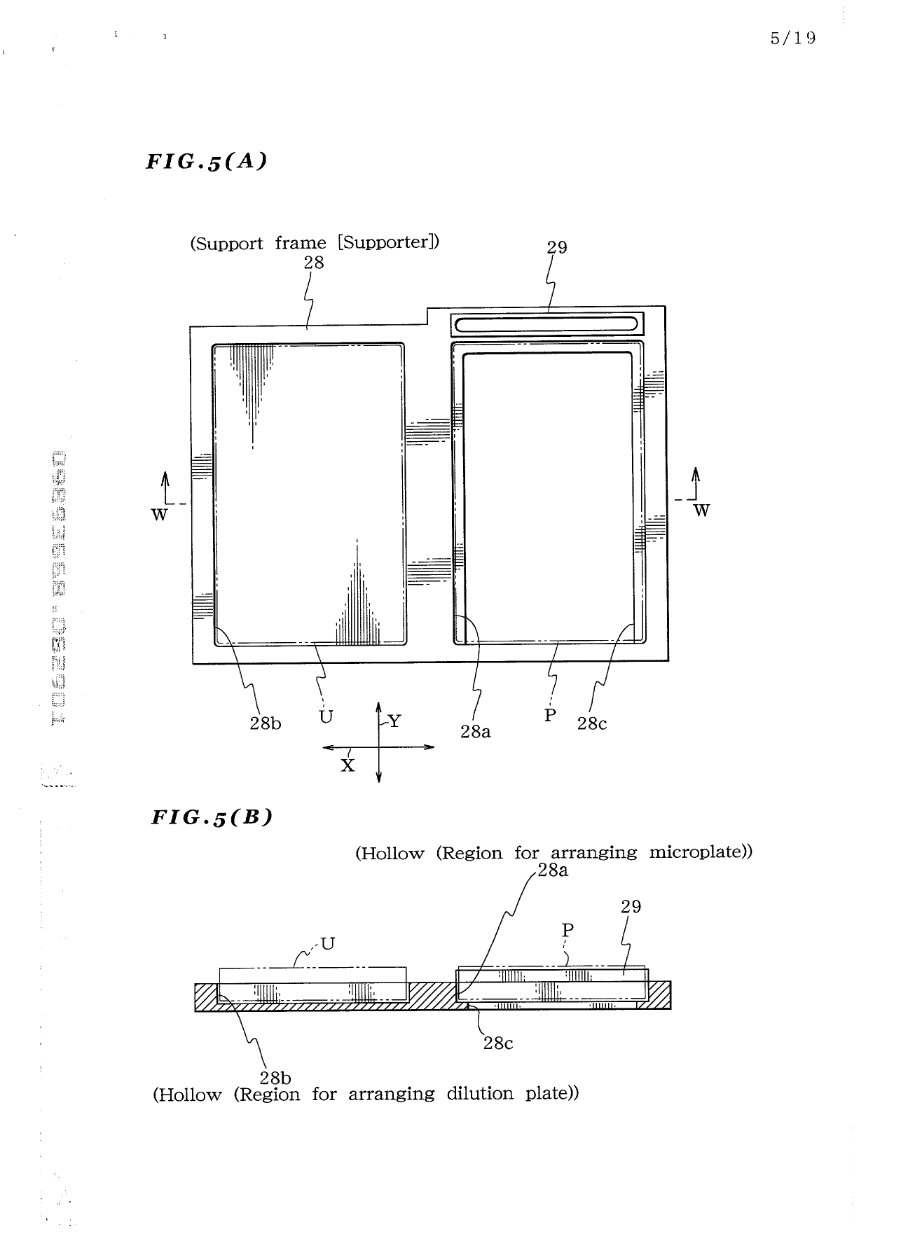

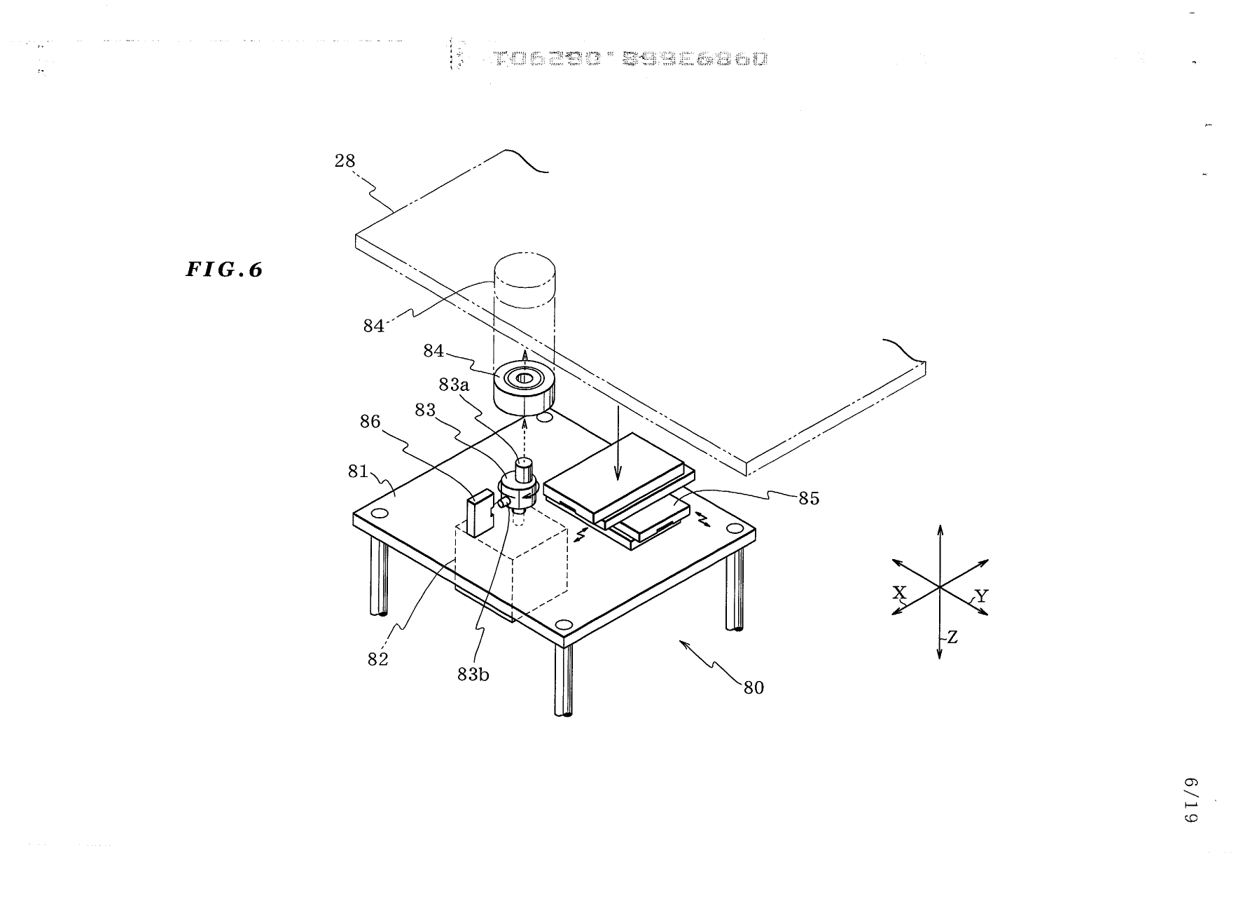

A support frame 28 for supporting the assay plate P and the dilution plate U is provided on the tray board 27 via a vibrating mechanism 80. FIGS. 5A and 5B are a plan view and a cross-sectional view (cut along line W-W in FIG. 5A) of the support frame 28, respectively. FIG. 6 is an exploded perspective view of the vibrating mechanism 80.

The support frame 28 and the vibrating mechanism 80 are provided at one end of the tray board 27 in the X-direction, adjacent to the above-described diluent tips stock unit 24. The support frame 28 is a plate having hollows 28a and 28b for placing the assay plate P and the dilution plate P, respectively. The shapes and the sizes of the hollows 28a and 28b are such that the plates P and U fit within the hollows 28a and 28b, respectively. The support frame 28 is arranged on the tray board 27 such that the longitudinal sides of the plates P and U (the side with 12 wells) are placed in the Y-direction. As shown in FIG. 4, the right half of the support frame 28 where the assay plate P is to be arranged protrudes from the tray board 27 in the X-direction.

As shown in FIGS. 5A and 5B, the bottom surface of the hollow 28a of the support frame 28 is provided with a large aperture 28c penetrating through the back of the support frame 28. The size of the aperture 28c is determined such that almost the entire area (except the circumference) of the back of the assay plate P is exposed. The aperture 28c is provided for heating the assay plate P from underneath by the later-described temperature maintaining mechanism 50 and for detecting the transmitted light beam by the photometer 70.

A wash bath 29 is provided in the support frame 28 and adjacent to the hollow 28a in the Y-direction, for washing the tip of the later-described sucking nozzle of the washing mechanism 60. The width of the wash bath 29 is generally equal to the width of the assay plate P in the X-direction. During the washing process, the washing solution is repeatedly discharged into and sucked from the wash bath 29 to wash the tip of the sucking nozzle.

(Vibrating Mechanism)

As described above, the support frame 28 is mounted on the tray board 27 via the vibrating mechanism 80. As shown in FIG. 6, the vibrating mechanism 80 is provided with: a base plate 81 firmly mounted on the tray board 27 via four legs; a vibrating motor 82 firmly attached to the back surface of the base plate 81, with the rotation axis being upright (i.e., perpendicular to both X- and Y-directions, hereinafter this direction is referred to as Z-direction); an eccentric cam 83 attached to the driving axis of the vibrating motor 82; a bearing 84 for rotatably connecting an eccentric shaft 83a of the eccentric cam 83 to the support frame 28; a slider connector 85 for connecting the support frame 28 to the base plate 81 such that the support frame 28 is capable of sliding in horizontal directions (in both X- and Y-directions); and an original position sensor 86 for detecting the original position of the support frame 28 with respect to the base plate 81.

The vibrating motor 82 is a servomotor which can freely control the number and the angle of rotation, and which always ends the vibration at a predetermined rotation angle so that the position of the support frame 28 after the vibration does not change with respect to the base plate 81.

One end of the eccentric cam 83 is connected to the driving axis of the vibrating motor 82, and the other end is provided with the eccentric shaft 83a that is parallel but eccentric to the driving axis. By connecting the eccentric shaft 83a to the support frame 28 via the bearing 84, driving the vibrating motor 82 will cause a circular motion of the support frame 28 with the driving axis being the center and the eccentric distance of the eccentric shaft 83a being the radius of the movement.

The connector 85 for connecting the base plate 81 to the support frame 28 is formed of a combination of two sliders that allow sliding movement of one slider in the longitudinal direction of the other slider. The connector 85 is mounted between the base plate 81 and the support frame 28, such that one slider slides in the X-direction while the other slides in the Y-direction. Thus, the support frame 28 can slide in any horizontal direction without changing its angle. Accordingly, driving the vibrating motor 82 will move the support frame 28 in a circular movement parallel to the horizontal surface without changing its angle.

A bump 83b is provided on the circumferential surface of the eccentric cam 83. The above-described original position sensor 86 detects the presence of the bump 83b and outputs a detection signal to the personal computer that controls the operation of the enzyme immunoassaying apparatus 10. Based on the detection of the bump 83b, the personal computer judges that the support frame 28 is at the original position and halts the vibrating motor 82 at that rotation angle, thereby ending the vibration operation. Accordingly, the position of the support frame 28 with respect to the base plate 81 can be constant before and after the vibration operation, thereby preventing malfunctions caused by misalignment of the assay plate P upon other operations (e.g., dispensing, washing, heating, assaying, and the like of the assay plate P).

(Stage Unit)

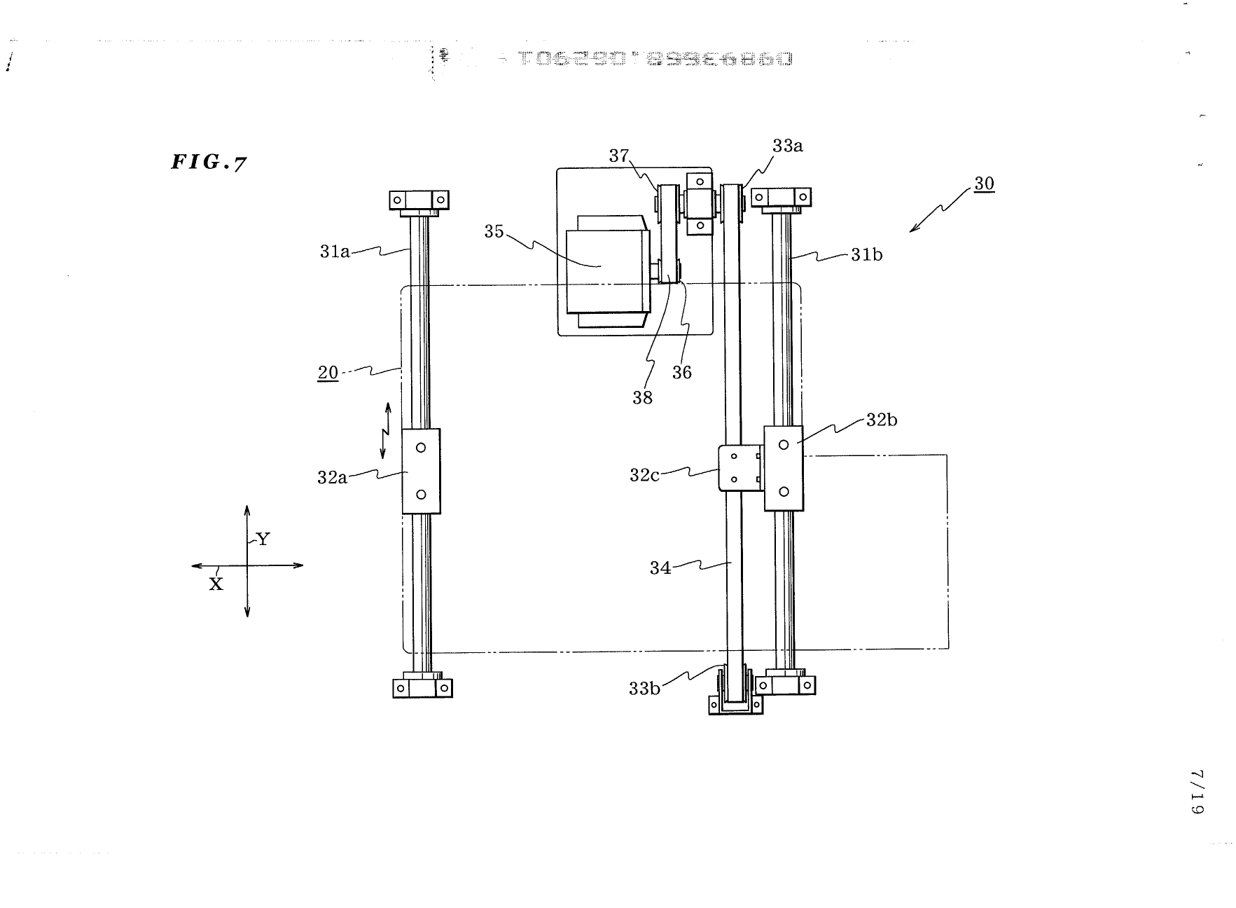

Next, the stage unit 30 will be described with reference to FIGS. 2 and 7. The stage unit 30 is provided with: two guiding shafts 31a and 31b for guiding the reagent/sample tray 20 in the Y-direction; sliders 32a and 32b firmly attached on the back surface of the reagent/sample tray 20 and capable of sliding along the guiding shafts 31a and 31b, respectively; an endless belt 34 stretching in the Y-direction between two driven pulleys 33a and 33b; a driving motor 35 as the source for driving the endless belt 34; a driving pulley 36 attached to the output axis of the driving motor 35; a reduction pulley 37 coaxially connected to the driven pulley 33a; and a transmission belt 38 for transmitting torque of the driving pulley 36 to the reduction pulley 37.

Both of the guiding shafts 31a and 31b extend in the Y-direction and are fixed to the base 11 (not shown in FIG. 7) at both ends. The sliders 32a and 32b include linear motion ball bearings engaging with the guiding shafts 31a and 31b, respectively, so that they can slide along the guiding shafts 31a and 31b, respectively. The sliders 32a and 32b are attached to the back surface of the tray board 27 of the reagent/sample tray 20 so that the entire reagent/sample tray 20 can reciprocate in the Y-direction.

The driven pulleys 33a and 33b and the endless belt 34 are all arranged near the guiding axis 31b. The slider 32b is connected at the center of the endless belt 34 via a bracket 32c. Thus, the endless belt 34 is driven to move the reagent/sample tray 20 reciprocally via the slider 32b.

The reduction pulley 37 and the driven pulley 33a are coaxially supported at both ends of a shaft for an interlocking movement. The driving pulley 36 has a smaller diameter than that of the reduction pulley 37 so that the rotation speed transmitted to the reduction pulley 37 is reduced.

The driving motor 35 is a servomotor capable of controlling the rotary amount. By controlling the rotary amount, the reagent/sample tray 20 can be aligned in the Y-direction.

(Temperature Maintaining Mechanism)

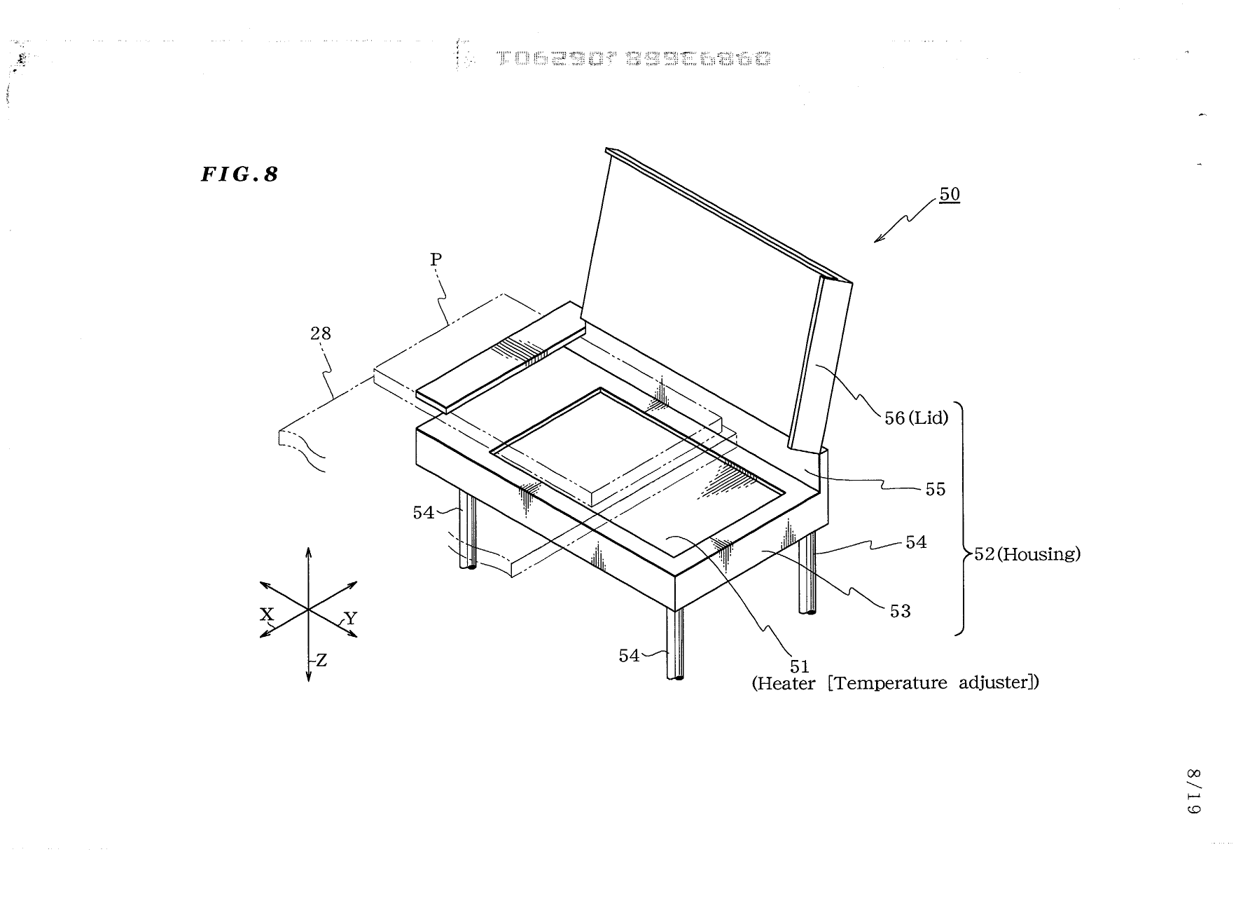

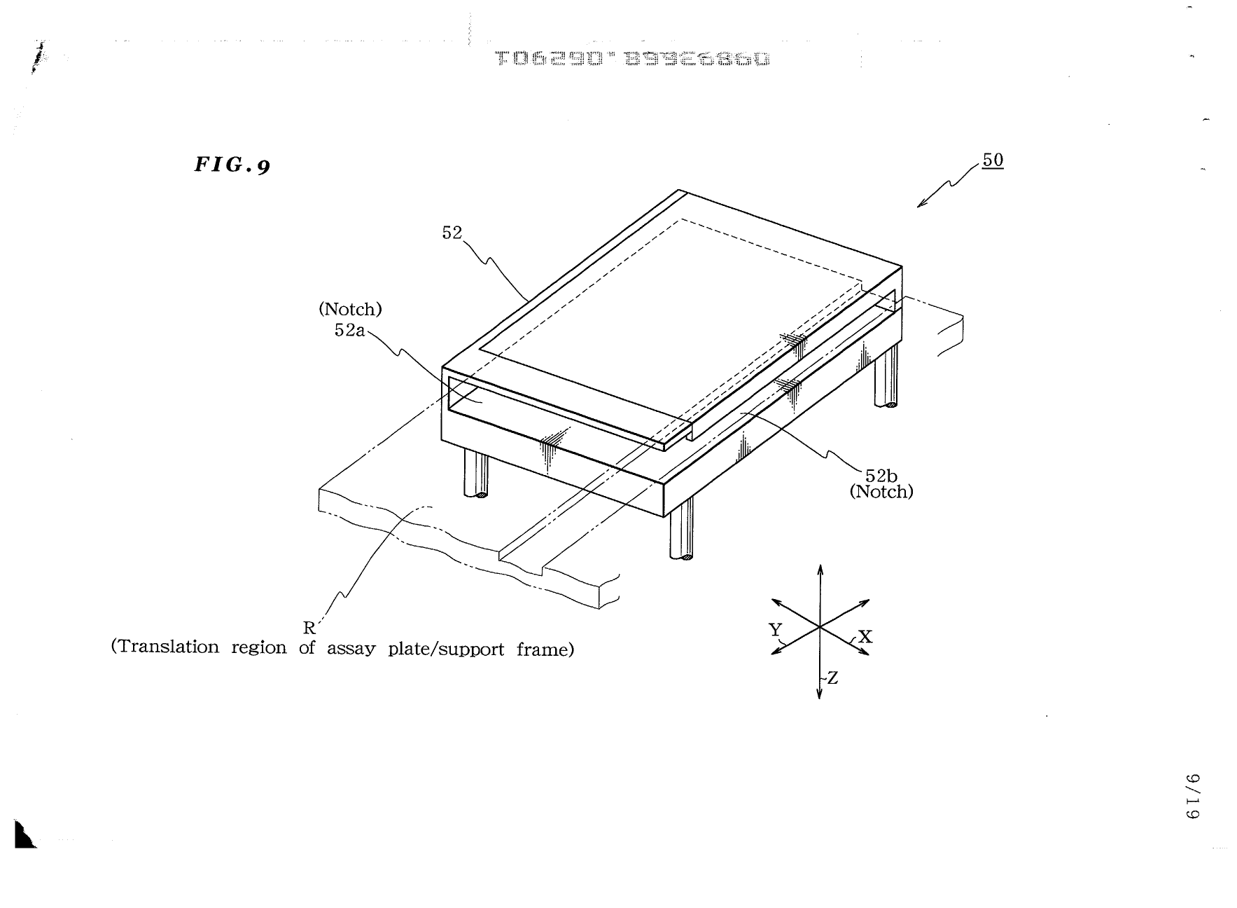

Referring to FIG. 2, the temperature maintaining mechanism 50 is placed at the front side (i.e., lower side in FIG. 2) of the base 11, adjacent to the support frame 28 side (i.e., the right side in FIG. 2) of the reciprocating region of the reagent/sample tray 20. The temperature maintaining mechanism 50 will be described with reference to FIGS. 8 and 9. FIG. 8 is a perspective view of the temperature maintaining mechanism 50 with a later-described lid 56 being opened. FIG. 9 is a perspective view showing the relationship between the translation region R of the assay plate/support frame and a housing 52 of the temperature maintaining mechanism 50.

The temperature maintaining mechanism 50 is provided with a heater 51 as a temperature adjuster and the housing 52 for accommodating the heater 51. The temperature of the heater 51 can be set by a control panel (not shown). The temperature adjustor is not limited to the heater and may be, for example, a Peltier element which can be used not only for heating but also for cooling.

The housing 52 includes a main body 53 for holding the heater 51, four legs 54 for supporting the main body 53 on the base 11 (not shown), and a lid 56 which can be opened and closed and which is positioned at the upper end of a side wall 55 standing on the upper surface of the main body 53.

The above-described heater 51 is provided on the upper surface of the main body 53. The lid 56 is attached to the side wall 55 such that when it is in the closed position, it faces the heater 51 via the translation region of the assay plate P/support frame 28. Specifically, a gap is provided between the main body 53 and the lid 56, which allows the thickness (height) of the support frame 28 holding the assay plate P so that the assay plate P and the support frame 28 conveyed by the movement of the reagent/sample tray 20 can be inserted into the gap. When the assay plate P is inserted between the main body 53 and the lid 56, the assay plate P is sandwiched with the heater 51 below and the lid 56 above. As described above, since the hollow 28a of the support frame 28 has the aperture 28c, the back surface of the assay plate P directly faces the heater 51 without any shielding. Thus, heat from the heater 51 can efficiently be transferred to the back surface of the assay plate P. In addition, since the lid 56 is in the vicinity of the openings of the wells P1 of the assay plate P, the moisture contained in the sample, the reagents or the like in the wells P1 can be prevented from evaporating.

FIG. 9 shows the housing 52 with the lid 56 being closed. In FIG. 9, symbol R represents the translation region of the assay plate P/support frame 28 defined by the movement of the reagent/sample tray 20. As can be appreciated from the figure, the temperature maintaining mechanism 50 is arranged on the base 11, overlapping with the end of the region R. The housing 52 is notched for receiving the translation region R of the assay plate/support frame. Specifically, notches 52a and 52b facing the Y- and X-directions, respectively, are formed to allow the assay plate P and the support frame 28 to be guided inside the housing 52 according to the translation of the reagent/sample tray 20.

(Photometer)

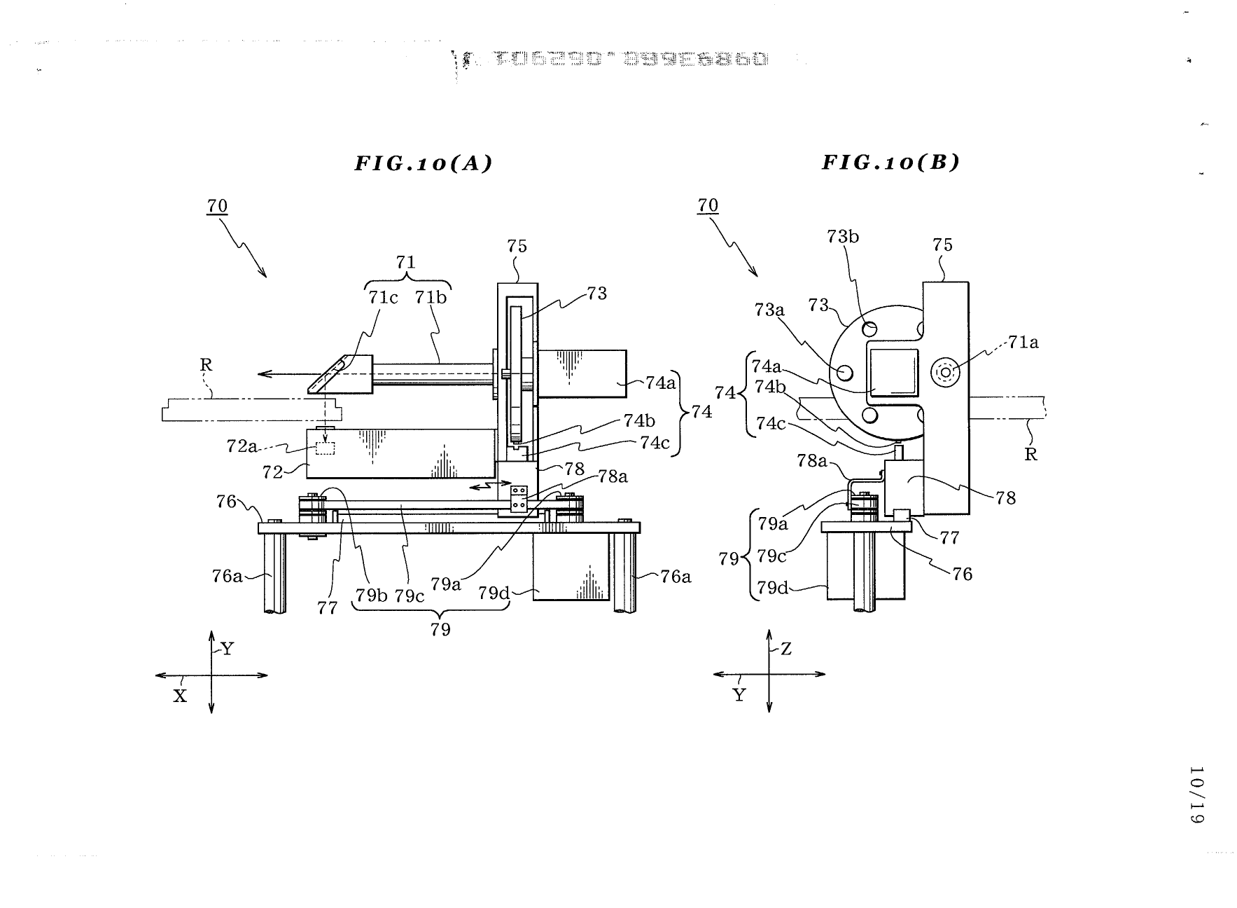

Referring to FIG. 2, the photometer 70 is arranged on the base 11, behind (i.e., upper side in FIG. 2) the temperature maintaining mechanism 50 in the Y-direction, and adjacent to the support frame 28 side (i.e., right side in FIG. 2) of the reciprocating region of the reagent/sample tray 20. The photometer 70 will be described with reference to FIGS. 10A and 10B, which are a front view and a side view of the photometer 70, respectively.

The photometer 70 is provided with: a radiation unit 71 for radiating light from a halogen lamp 71a as a light source to the wells P1 of the assay plate P; a sensor supporter 72 including a photodiode 72a as a light-receiving sensor; a filter supporter 73 including a various types of band pass filters 73a appropriate for determinations; a filter selecting means 74 for driving the filter supporter 73; a bracket 75 for supporting the radiation unit 71, the sensor supporter 72 and the filter supporter 73; a base plate 76 mounted on the base 11 (not shown in FIGS. 10A and 10B) with two legs 76a; a guiding member 77 mounted on the base plate 76; a slider 78 slidable along the guiding member 77; and a positioning means 79 for moving the slider 78 reciprocally.

The radiation unit 71 includes the halogen lamp 71a, a guiding tube 71b which transmits the light from the halogen lamp 71a, and a mirror 71c that reflects off the transmitted light toward the sensor supporter 72. The guiding tube 71b extends from the bracket 75 in the X-direction. The distance from the root of the guiding tube 71b to the mirror 71c on the tip of the guiding tube 71b is longer than the width (shorter side) of the assay plate P in the X-direction.

The disk-shaped filter supporter 73 is inserted between the halogen lamp 71a and the guiding tube 71b. Various types of band pass filters 73a with different pass bands (five types in the present embodiment) are provided along the circumference of the filter supporter 73. A throughhole 73b without the band pass filter 73a is also provided along the circumference of the filter supporter 73.

The filter selecting means 74 is provided with: a servomotor 74a for rotating the filter supporter 73; an original position bump 74b provided on the peripheral of the filter supporter 73; and an original position sensor 74c for detecting the original position bump 74b. The original position bump 74b is detected by the original position sensor 74c, and then the filter supporter 73 is rotated by a predetermined angle by the servomotor 74a, thereby aligning the desired band pass filter 73a with respect to the halogen lamp 71a and then emitting light wave of a predetermined wavelength from the radiation unit 71.

The sensor supporter 72 also extends from the bracket 75 in the X-direction. The distance from the root of the sensor supporter 72 to the photodiode 72a at the tip of the sensor supporter 72 is equal to the distance from the root of the guiding tube 71b to the mirror 71c on the tip of the guiding tube 71b. As shown in FIGS. 10A and 10B, the heights of the guiding tube 71b and the sensor supporter 72 are determined such that the translation region R of the assay plate/support frame is positioned between the guiding tube 71b and the sensor supporter 72. Accordingly, by moving the reagent/sample tray 20, the assay plate P is guided between the guiding tube 71b and the sensor supporter 72. The light transmitted through each well P1 is detected with the photodiode 72a, thereby obtaining the measurement results based on the absorbance.

The slider 78 supports the bracket 75, and the guiding member 77 is mounted on the base plate 76 along the X-direction. Thus, sliding of the slider 78 can change the detection position by the photodiode 72a along the X-direction. The positioning means 79 for moving the slider 78 includes an endless belt 79c stretching in the X-direction between a driving pulley 79a and a driven pulley 79b, and a servomotor 79d for rotating the driving pulley 79a. The slider 78 is connected to the center of the endless belt 79c via a small bracket 78a. By rotating the servomotor 79d, the detection position of the photodiode 72a can be positioned along the X-direction via the slider 78 and the bracket 75. Specifically, the photodiode 72a is positioned with respect to each one of wells P1 lined in the X-direction to measure the absorbance for all of the wells P1 on that line. Since the assay plate P can travel in the Y-direction by the translation of the reagent/sample tray 20 as described above, this traveling movement and the positioning movement of the photodiode 72a in the X-direction can be combined together to determine the absorbance for all of the wells P1 of the assay plate P.

(Washing Mechanism)

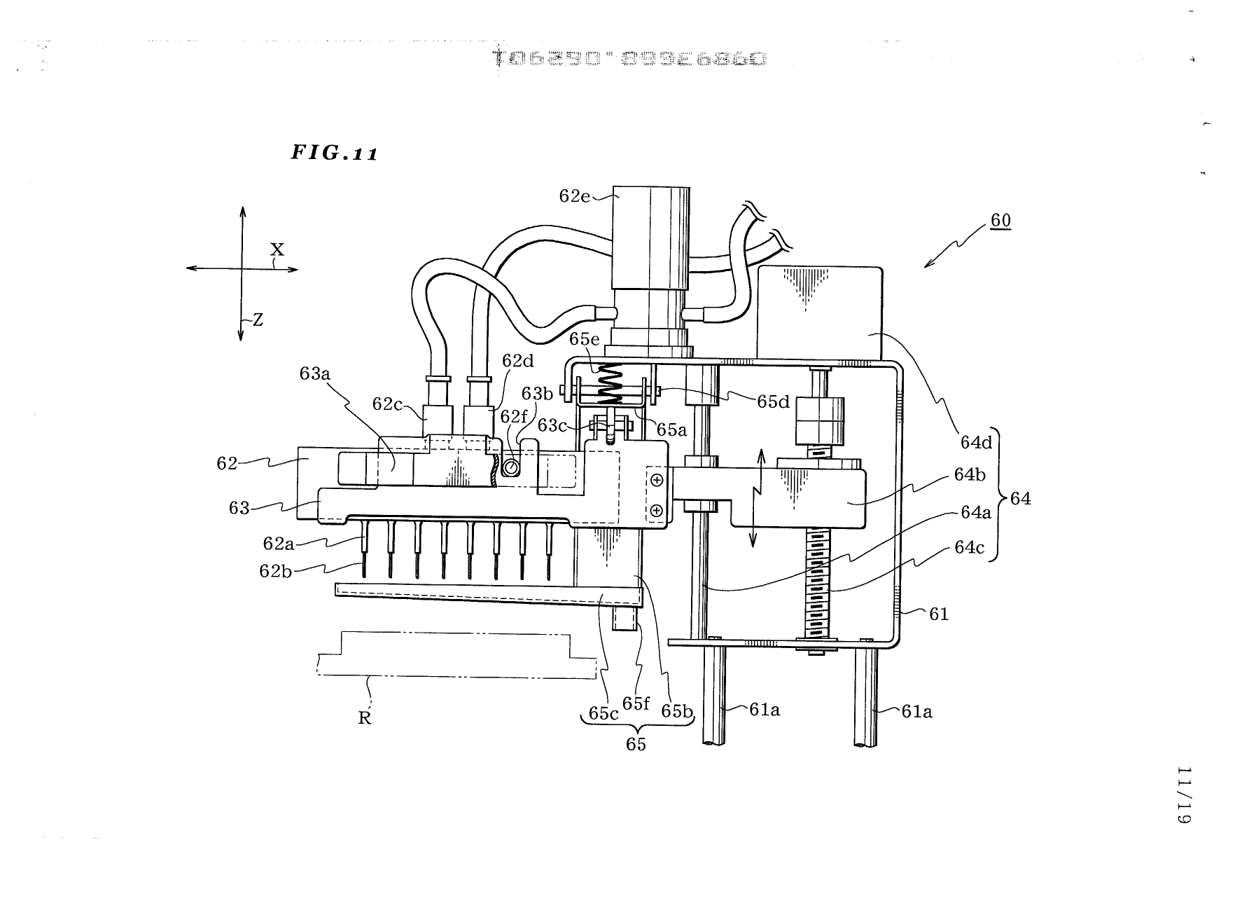

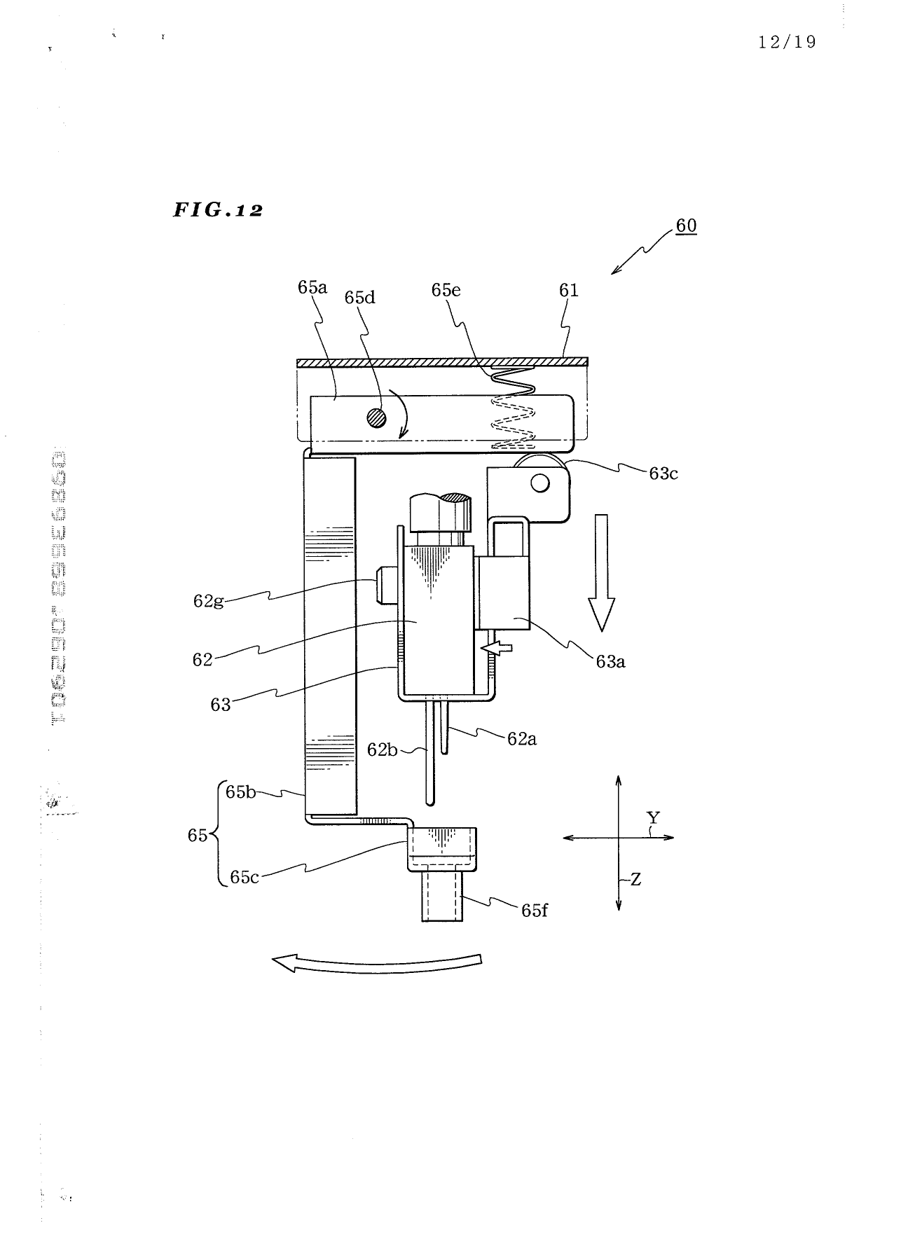

Referring to FIG. 2, the washing mechanism 60 is arranged on the base 11 behind (i.e., upper side in FIG. 2) the photometer 70 in the Y-direction, and adjacent to the support frame 28 side (i.e., right side in FIG. 2) of the reciprocating region of the reagent/sample tray 20. The washing mechanism 60 will be described with reference to FIGS. 11 and 12. FIG. 11 is a front view of the washing mechanism 60, and FIG. 12 is a left-side view of the washing mechanism 60 where some parts are omitted. The parts behind a later-described nozzle cover 65 are not shown in FIG. 12.

The washing mechanism 60 is provided with: a main chassis 61 attached to the base 11 (not shown in FIGS. 11 and 12) by four legs 61a; a washing manifold 62 including eight sets of washing solution discharging nozzles 62a and sucking nozzles 62b; a holder 63 for holding the washing manifold 62; an elevator 64 for ascending/descending the washing manifold 62 via the holder 63 with respect to the main chassis 61; the nozzle cover 65 for receiving drippings from the nozzles 62a and 62b of the washing manifold 62; a washing solution tank (not shown); and washing solution pressure and suction pumps.

The washing manifold 62 has a parallelepiped shape with one set of sides being longer than the other set of sides. The pairs of washing solution discharging nozzles 62a and sucking nozzles 62b are provided at equal spaces under the washing manifold 62 along the longer sides thereof. The sucking nozzles 62b are longer than the washing solution discharging nozzles 62a. The space between each nozzle is equal to the space between each well P1 of the assay plate P in the X-direction. The top surface of the washing manifold 62 is provided with a solution supplying port 62c communicating with the washing solution discharging nozzles 62a and a suction port 62d communicating with the sucking nozzles 62b. The solution supplying port 62c is connected to the washing solution pressure pump and a washing solution tank via a hose while the suction port 62d is connected to the suction pump via a hose.

The reference numeral 62e denotes a bulb which can be opened and closed according to the instruction from the personal computer. While the pumps are generally driven continuously, the washing solution is discharged from the washing solution discharging nozzles 62a only when the bulb is opened.

Furthermore, positioning bumps 62f and 62g are provided in front and back of the washing manifold 62. The positioning bumps 62f and 62g are fit into notches formed in the holder 63 to align the washing manifold 62 with respect to the holder 63 in the X-direction.

The main chassis 61 holding the washing manifold 62 via the elevator 64 and the holder 63 is arranged on the base 11 such that the longitudinal side (direction along the lines of the pairs of nozzles) of the washing manifold 62 is parallel to the X-direction, and that the pairs of nozzles are positioned above the respective wells P1 lined in the X-direction on the assay plate P which moves across the translation region R. To be more specific, the main chassis 61 is arranged such that the pairs of nozzles correspond to the center of the respective wells P1 in the X-direction.

The elevator 64 includes: a guiding member 64a firmly attached to the main chassis 61 in the Z-direction; a slider 64b supported by and slidable along the guiding member 64a; a screw shaft 64c rotatably attached to the main chassis 61 and extending in the Z-direction; and a servomotor 64b for rotating the screw shaft 64c.

The slider 64b firmly supports the holder 63 and transmits the ascending/descending movement to the washing manifold 62 via the holder 63. The slider 64b is engaged with the screw shaft 64c via a ball screw (not shown), and is ascended or descended according to the rotation of the screw shaft 64c.

The elevator 64 can adjust the height of the washing manifold 62 to the following three levels; the level where the sucking nozzles 62b of the washing manifold 62 are placed separated from and above the assay plate P (state shown in FIGS. 11 and 12, referred to as the set back level); the level where the sucking nozzles 62b of the washing manifold 62 stay immediately above the wells P1 of the assay plate P (referred to as the discharging level); and the level where the tips of the sucking nozzles 62b of the washing manifold 62 reach the bottoms of the wells P1 (referred to as the sucking level). By providing the main chassis 61 with sensors for detecting the slider 64b at these levels, a general driving motor can be used instead of the servomotor 64d for controlling the rotary amount.

The holder 63 is supported by the slider 64b so as to be positioned along the X-direction, with its length generally corresponding to the length of the longitudinal sides of the washing manifold 62. The holder 63 has a U-shaped section with the top side being open as shown in FIG. 12. The washing manifold 62 is inserted into the space of the holder 63 from the open top. The width of the space of the holder 63 is slightly wider than the thickness of the washing manifold 62 to give a slight play inside the holder 63 supporting the washing manifold 62. The holder 63 is provided with a spring 63a that elastically presses the inserted washing manifold 62, thereby preventing the washing manifold 62 from moving in the Y-direction. Since the holder 63 supports the washing manifold 62 with the play and the pressure by the spring, the sucking nozzles 62 can make contact with and be pressed against the inner walls of the wells P1 for sucking operation, thereby effectively removing liquid from the wells P1.

The counter planes of the U-shaped sectional holder 63 have notches 63b (only one notch being shown) corresponding to the positioning bumps 62f and 62g of the above-described washing manifold 62. The notches 63b allow each pair of nozzles of the washing manifold 62 to be positioned and fixed in the X-direction.

A contact roller 63c for swaying the nozzle cover 65 is provided above the holder 63. The contact roller 63c is ascended/descended according to the movement of the slider 64b.

As shown in FIG. 12, the nozzle cover 65 is provided with a first arm 65a that faces the upper plane of the main chassis 61; a second arm 65b whose one end is connected to one end of the first arm 65a; and a reservoir 65c provided at the other end of the second arm 65b. The first arm 65a is connected to the main chassis 61 in the vicinity of its one end capable of swaying with respect to the spindle 65d extending in the X-direction. The other end of the first arm 65a is provided with a pressure spring 65e which separates the first arm 65a away from the main chassis 61.

The second arm 65b is connected generally perpendicular to the first arm 65a. Thus, when the first arm 65a is horizontal, the end of the second arm 65b points down. In such a state, the reservoir 65c is positioned immediately below the nozzles of the washing manifold 62 by slightly being shifted to the right (FIG. 12) from the end of the second arm 65b. The length of the reservoir 65c generally corresponds to the length of the washing manifold 62 in the X-direction, and the reservoir 65c is supported by the second arm 65b in the X-direction. The bottom of the reservoir 65c is slanted in the x-direction such that one end (right end in FIG. 11) is lower than the other. An outlet 65f is provided at one end of the reservoir 65c to collect and discharged residual liquid dripped from the nozzles 62a and 62b. A waste fluid reservoir (not shown) is provided below the outlet 65f.

As described above, the levels of the washing manifold 62 and the holder 63 are adjusted among the three levels (i.e., set back level, discharging level and sucking level) by the elevator 64. The contact roller 63c provided on the holder 63 makes contact with the pressure spring having an opposite force such that the first arm 65a of the nozzle cover 65 is horizontal at the set back level. Accordingly, when the washing manifold 62 and the holder 63 are descended to the discharging or sucking level, the first arm 65a is pressed down by the pressure spring 65e, by which the reservoir 65c is swayed away from the position immediately below the nozzle pairs so as not to interfere with the washing operation.

(Dispensing Mechanism)

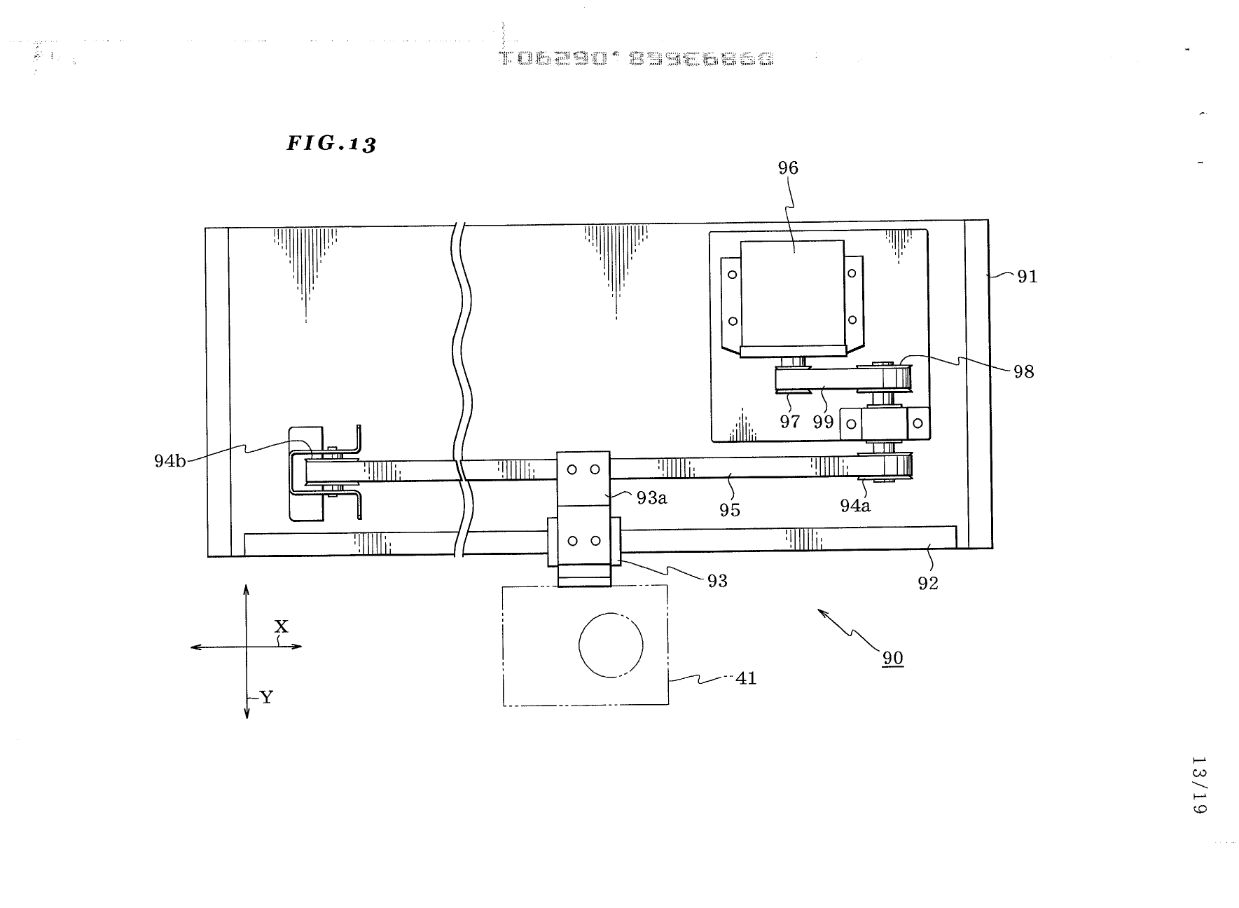

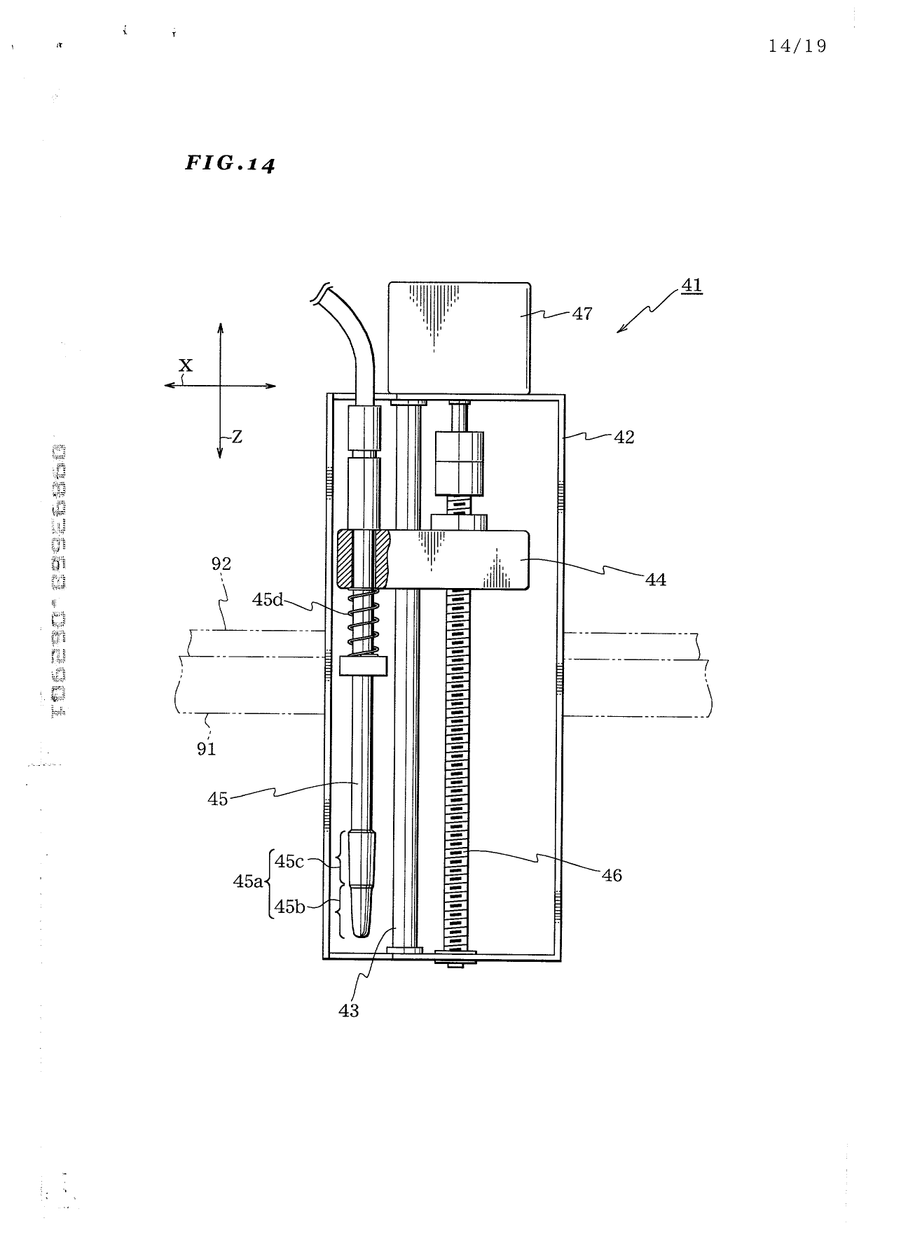

Referring to FIG. 2, the dispensing mechanism 40 is arranged on the base 11 behind (i.e., upper side in FIG. 2) the washing mechanism 60 in the Y-direction. The dispensing mechanism 40 includes a dispenser 41 for dispensing the samples and the reagents and a conveyer 90 for transferring the dispenser 41 in the X-direction. FIG. 13 is a plan view of the conveyer 90 and FIG. 14 is a front view of the dispenser 41. The dispensing mechanism 40 will be described with reference to FIGS. 13 and 14.

As shown in FIG. 13, the conveyer 90 is provided with: an installation stand 91 (see FIGS. 1 and 2) mounted on the base 11 across the translation region of the reagent/sample tray 20 holding the support frame 28; a guiding rail 92 mounted on the installation stand 91 in the X-direction; a slider 93 for supporting the dispenser 41 and capable of sliding along the guiding rail 92; an endless belt 95 stretching in the X-direction between two driven pulleys 94a and 94b; a servomotor 96 as a driving source for running the endless belt 95; a driving pulley 97 attached to the output axis of the servomotor 96; a reduction pulley 98 coaxially connected to the driven pulley 94a; and a transmission belt 99 for transmitting torque of the driving pulley 97 to the reduction pulley 98.

The guiding rail 92 is mounted on the front side of the installation stand 91 in the X-direction. Since the slider 93 is slidable along the guiding rail 92, the dispenser 41 can be moved to any position along the X-direction. The driven pulleys 94a and 94b and the endless belt 95 are arranged in the vicinity of the guiding rail 92. The slider 93 is connected to the center of the endless belt 95 via a bracket 93a. Thus, by running the endless belt 95, the dispenser 41 can be aligned along the X-direction via the slider 93.

The reduction pulley 98 and the driven pulley 94a are coaxially supported at both ends of the same axis for an interlocking movement. The diameter of the driving pulley 97 is smaller than that of the reduction pulley 98 so that the rotation speed transmitted to the reduction pulley 98 is reduced. The servomotor 96 can control the rotary amount, by which the dispenser 41 is aligned along the X-direction.

The dispenser 41 includes a dispensing nozzle 45, and an elevating means for ascending/descending the dispensing nozzle 45 in the Z-direction. The elevating means is provided with: a housing 42 held by the slider 93 of the conveyer 90; a guiding member 43 firmly attached to the housing 42 and extending along the Z-direction; a slider 44 for supporting the dispensing nozzle 45 and capable of sliding along the guiding member 43; a screw shaft 46 rotationally attached to the housing 42 in the Z-direction; and a servomotor 47 for rotating the screw shaft 46.

The housing 42 has a parallelepiped shape with one set of sides being longer than the other set of sides. The slider 93 of the conveyer 90 holds the housing 42 such that the longitudinal sides of the housing 42 extend in the Z-direction. The slider 44 of the dispenser 41 is engaged to the screw shaft 46 via a ball screw (not shown), and ascended/descended according to the rotation of the screw shaft 46. The servomotor 47 can control the rotary amount, by which the dispensing nozzle 45 can be positioned along the Z-direction via the slider 44.

The dispensing nozzle 45 is a tubular member held by the slider 44 along the Z-direction, with its root end (upper end) being connected to a dispensing pump (not shown) via a hose for suction and discharging. The dispensing pump used should be capable of controlling the sucking and discharging amounts. The tip (bottom end) of the dispensing nozzle 45 has an attachment member 45a for attaching a sample tip T1, a diluent tip T2 or a reagent tip T3.

The attachment member 45a has a small diameter section 45b and a large diameter section 45c so as to allow any one of the sample tip T1 and the diluent tip T2 with small diameters, and the reagent tip T3 with a large diameter to be attached thereto. As shown in FIG. 15A, the sample tip T1 or the diluent tip T2 is attached to the small diameter section 45b. As shown in FIG. 15B, the reagent tip T3 is attached to the large diameter section 45c.

The dispensing nozzle 45 is capable of sliding along the slider 44 in the Z-direction, and is always pressed down by a coil spring 45d. This structure allows the attachment of the above-described tips T1, T2 and T3. Specifically, the tip T1, T2 or T3 is attached by descending the dispensing nozzles 45 to the tip T1, T2 or T3 held by the holder 23, 24 or 25 with its attachment end facing upward to insert the attachment member 45a into the attachment end of the tip. The friction upon the insertion causes an up-directing force on the dispensing nozzle 45, by which the coil spring 45d is pressed up and the dispensing nozzle 45 moves up with respect to the slider 44. The distance of this upward movement of the dispensing nozzle 45 is detected by a sensor (not shown) to control the slider 44 and the dispensing nozzle 45 until a predetermined distance is obtained for the attachment of the tips T1, T2 and T3, thereby allowing uniform attachment of the tips T1, T2 and T3. In other words, the tip T1, T2 or T3 is attached with a preferable strength without being too tight or too loose. As a result, malfunction such as undesirable disconnection or being unable to take off the tip by too tight connection can be prevented.

(Tip Disposing Unit)

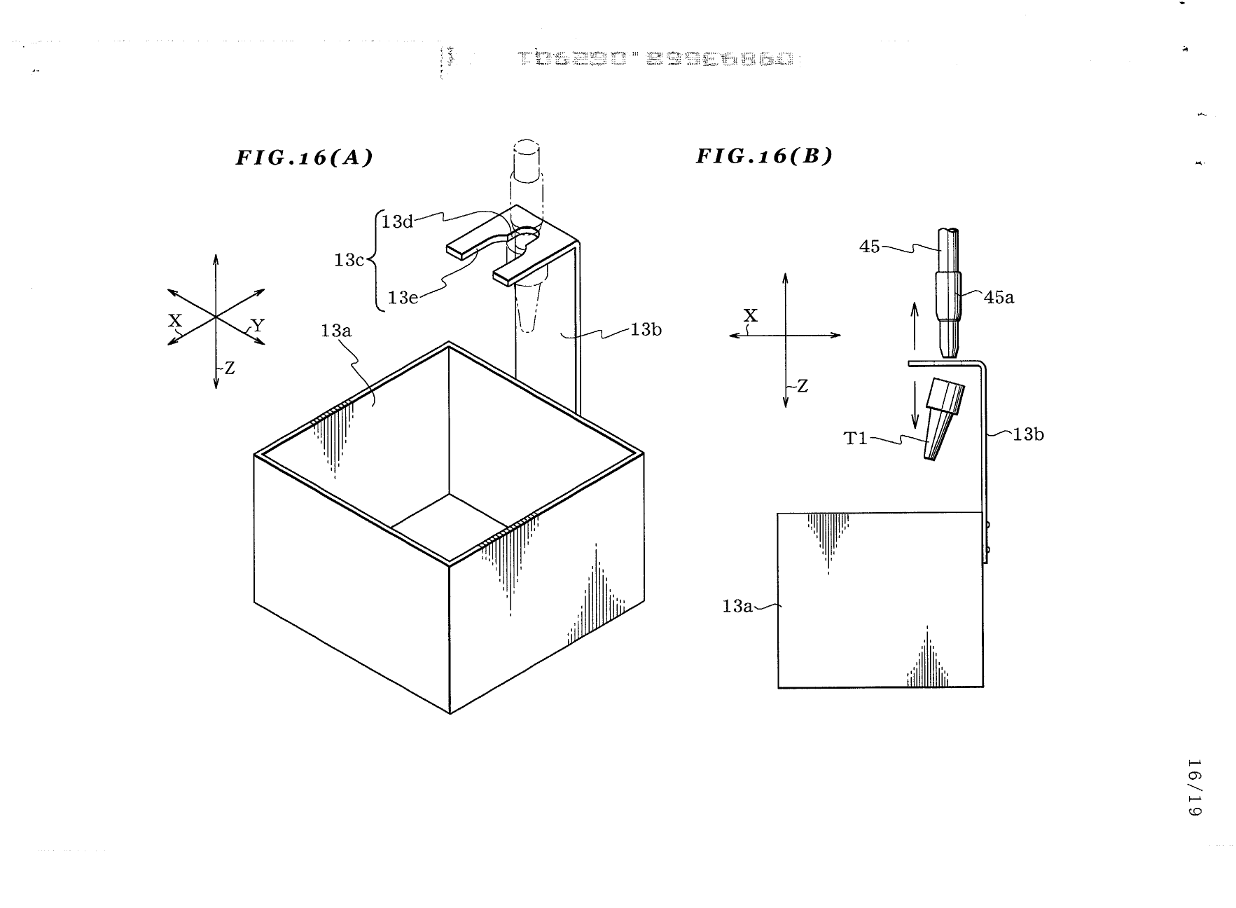

Referring to FIG. 2, a tip disposing unit 13 is arranged at the end (i.e., right side in FIG. 2) of the region where the dispensing portion 41 is carried by the conveyer 90 of the dispensing mechanism 40. The tip disposing unit 13 will be described with reference to FIGS. 16A and 16B. FIGS. 16A and 16B are a perspective view and a front view of the tip disposing unit, respectively.

The tip disposing unit 13 is provided with a collecting receptacle 13a for collecting the disposed tips T1, T2 and T3, and a tip catch 13b attached to the upper end of the collecting receptacle 13a. The upper end of the tip catch 13b is bent toward the dispenser 41 (to the left in FIG. 2) and is provided with a notch 13c having two width sizes.

The notch 13c is positioned in the middle of the path of the dispensing nozzle 45 transferred by the conveyer 90. The narrow part 13d of the notch 13c is wider than the diameter of the small diameter section 45b of the dispensing nozzle 45 and narrower than the diameter of the attachment ends of the tips T1 and T2. The wide part 13e is wider than the diameter of the large diameter section 45c of the dispensing nozzle 45 and narrower than the diameter of the attachment end of the tip T3.

Disconnection of the sample tip T1 by the tip disposing unit 13 will be described. First, the dispensing nozzle 45 with the sample tip T1 being attached thereto is transferred to the tip disposing unit 13. The notch 13c of the tip catch 13b is aligned in the tip disposing unit 13. And the height of the dispensing nozzle 45 is adjusted in advance such that the part of the small diameter section 45b where it is not covered with the sample tip T1 (part of the small diameter section 45b in the vicinity of the boundary with the large diameter section 45c) is inserted into the notch 13c. The dispensing nozzle 45 is conveyed until the small diameter section 45b fits into the narrow part 13d of the notch 13c. By moving the dispensing nozzle 45 upward, only the sample tip T1 is caught by the tip catch 13b, disconnected from the attachment member 45a of the dispensing nozzle 45 and disposed in the collecting receptacle 13a.

The diluent tip T2 can also be disconnected in exactly the same manner. In the case of the reagent tip T3, the part above the large diameter section 45c of the dispensing nozzle 45 is adjusted to the height of the notch 13c. The dispensing nozzle 45 is conveyed until the large diameter section 45c thereof fits into the wide part 13e of the notch 13c. Thereafter, the dispensing nozzle 45 may be moved upward.

(Plate Cover)

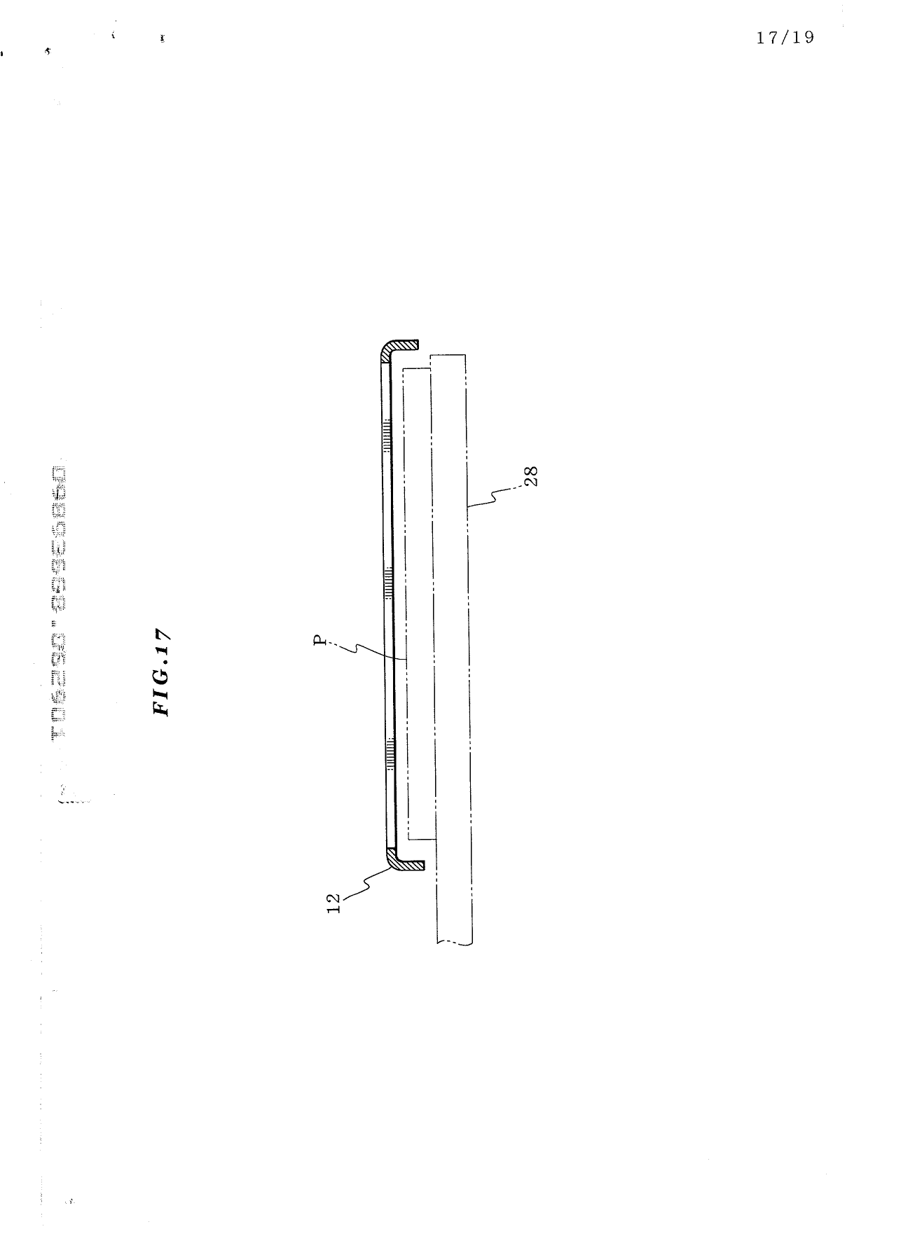

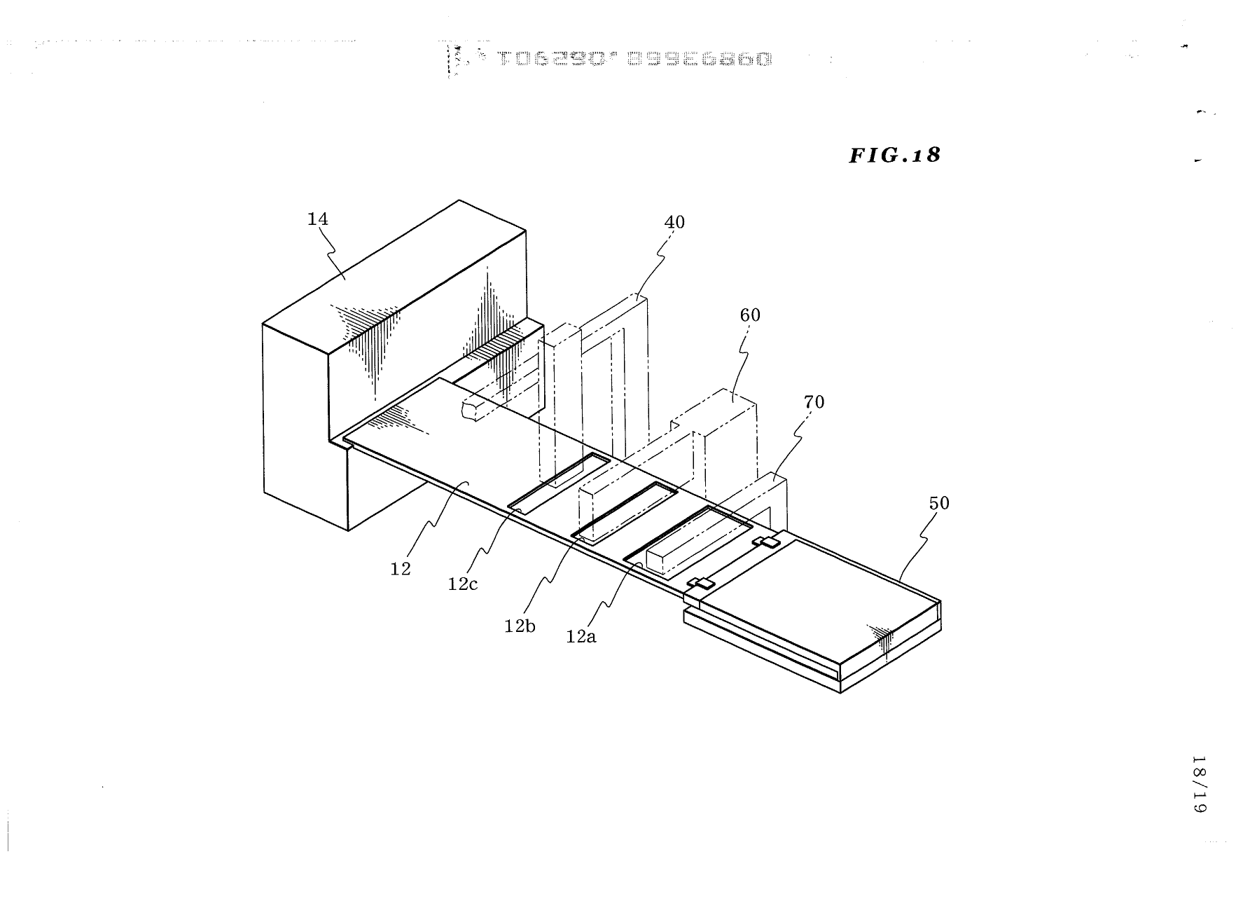

Referring to FIG. 2, the plate cover 12 for covering the top surface of the assay plate P held on the support frame 28 is generally formed over the entire translation region of the assay plate P defined by the movement of the reagent/sample tray 20. FIG. 17 is a schematic view for illustrating a positional relationship between the plate cover 12 and the assay plate P held on the support frame 28. FIG. 18 is a perspective view showing the plate cover 12. The plate cover 12 will be described with reference to FIGS. 17 and 18.

As shown in FIG. 18, the plate cover 12 has a flat board-like shape and is arranged with its longitudinal sides extending along the Y-direction between the temperature maintaining mechanism 50 and the power source 14. As shown in FIG. 17, the plate cover 12 is formed slightly wider than the width of the assay plate P in the X-direction, with the both sides being bent toward the assay plate P. The flat plane of the plate cover 12 is supported by the temperature maintaining mechanism 50 and the power source 14 such that it is parallel to and in the vicinity of the top surface of the assay plate P on the support frame 28.

The assay plate P is transferred to positions within the translation region, where the wells P1 thereof are subjected to the reaction determination, washing and dispensing of the sample/reagent. Since all of these operations are performed from above the assay plate P, the plate cover 12 is provided with openings for each operation. Specifically, openings 12a, 12b and 12c are provided corresponding to the positions of the photometer 70, the washing mechanism 60 and the dispensing mechanism 40, respectively. Each of the openings 12a, 12b and 12c extends for almost the whole width of the plate cover 12 in the X-direction. Thus, the plate cover 12 can cover all of the wells P1 while they are transferred or cover part of the wells P1 waiting for the operations without interfering with the operations, thereby effectively preventing evaporation of the moisture of the sample or the reagent contained in the open wells P1.

(Description of the Operation of the Enzyme Immunoassaying Apparatus)

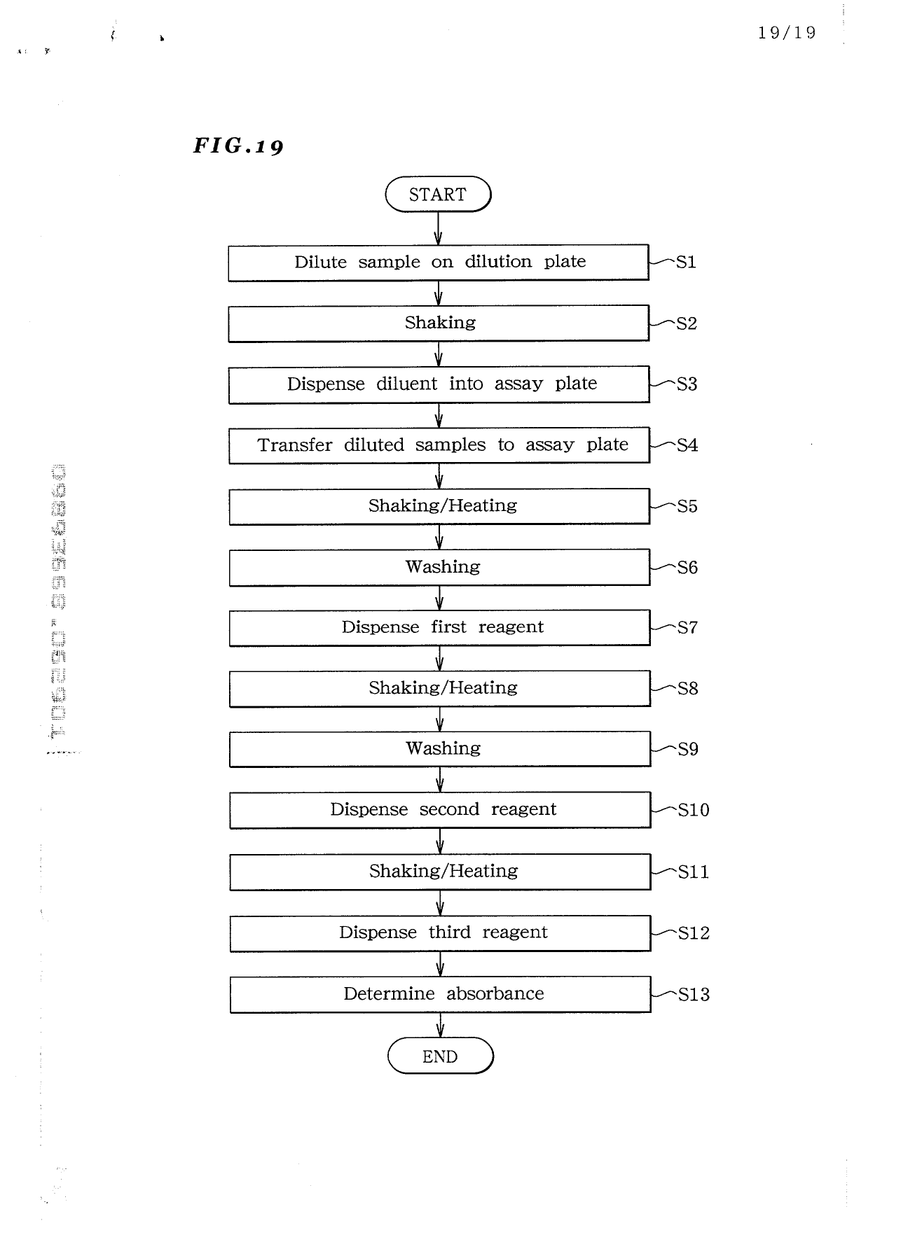

The operation of the enzyme immunoassaying apparatus 10 will be described with reference to FIGS. 2 and 19. FIG. 19 is a flowchart showing the sequential steps of the operation of the enzyme immunoassaying apparatus 10. Hereinafter, for convenience's sake, the upward direction in FIG. 2 is referred to as the proceeding direction, the downward direction as the returning direction, and the right and left directions as the same.

The operation of the enzyme immunoassaying apparatus 10 described below is implemented by programs executed by the above-described personal computer for controlling the operation of the enzyme immunoassaying apparatus 10.

First, as a preparatory arrangement, the assay plate P and the dilution plate U are mounted on the hollows 28a and 28b of the support frame 28, respectively. The assay plate P is mounted on the support frame 28 inside the temperature maintaining mechanism 50.

The reagent bottles S used for the assay and the diluent bottles are set into the reagent stock unit 21 on the reagent/sample tray 20, and the reagent tips T3 into the reagent tips stock unit 25. Furthermore, the sample tips stock unit 23 with the sample tips T1, the diluent tips stock unit 24 with the diluent tips T2 and the sample stock unit 22 with the sample containers K are set at respective positions on the reagent/sample tray 20.

After the preparatory arrangement, the operation of the enzyme immunoassaying apparatus 10 is initiated. First, the sample is diluted. Specifically, a diluent is dispensed into the wells U1 of the dilution plate U (Step S1) by using the reagent tip T3. The reagent tip T3 is used by positioning the dispensing nozzle 45 above a tip of the reagent tips stock unit 25 by the cooperation of the stage mechanism 30 and the conveyer 90 of the dispensing mechanism 40 and descending the dispensing nozzle 45 by the elevating means and the reagent tip T3 is attached.

Next, the dispensing nozzle 45 is positioned and descended to the diluent bottle held in the reagent stock unit 21 to suck a predetermined amount of the diluent with the reagent tip T3 by activating the dispensing pump.

The dilution plate U is sent to the operation region of the dispensing nozzle 45 by the stage mechanism 30. The dilution plate U is aligned such that the front-most row of wells U1 in the proceeding direction is positioned on the operation region of the dispensing nozzle 45. The dispensing nozzle 45 is positioned above the right-most well U1 in the front-most row of the dilution plate U by the conveyer 90 and descended to the discharging level to discharge the diluent. The dispensing nozzle 45 is sent to the left for dispensing the diluent into the rest of the wells U1 in that row in the X-direction in the same manner. After the diluent is dispensed into the wells U1 in the front-most row, the dilution plate U is sent to the proceeding direction for a line of wells U1 in the Y-direction by the stage mechanism 30 to perform the dispensing operation in the same manner.

Since the amount of the diluent to be discharged for each well U1 is predetermined based on the dilution ratio, the amount of the diluent in the reagent tip T3 as to the number of wells it can fill can be calculated. Thus, if necessary, the reagent tip T3 may appropriately be refilled with the diluent during the course of the dispensing operation for the dilution plate U.

Once the diluent is dispensed into all of the wells U1, the dispensing nozzle 45 is carried to the disposing member 13, where the reagent tip T3 is disposed.

Then, the sample is dispensed into each well U1. First, the dispensing nozzle 45 is sent to the sample tip holder 26 by the cooperation of the stage mechanism 30 and the conveyer 90, and a sample tip T1 at one of the tip positions is attached. After the attachment of the tip, the dispensing nozzle 45 is sent to the sample stock unit 22, where it is aligned with one of the sample containers K to suck a predetermined amount of the sample. The sample tip T1 and the sample container K may be selected in a sequential manner starting from the right-most ones in the front-most row.

After the suction of the sample, the dispensing nozzle 45 discharges the sample into the dilution plate U. The sample is discharged into the right-most well U1 in the front-most row, after which the sample tip T1 is disposed at the disposing member 13. Samples are discharged into the corresponding wells U1 in the similar manner.

After the samples are completely discharged into the wells U1 of the dilution plate U, the vibrating mechanism 80 is operated for a predetermined period of time to shake the wells U1 (Step S2).

On the other hand, a predetermined amount of diluent is dispensed into each of the wells P1 of the assay plate P (Step S3). The dispensing operation of the diluent is conducted in the same manner as Step S1. Specifically, the dispensing nozzle 45 is attached with the reagent tip T3, used to suck the diluent and is aligned to each well P1 to discharge the diluent. Thereafter, the reagent tip T3 is disposed.

Next, the diluted samples in the wells U1 of the dilution plate U are transferred to the corresponding wells P1 of the assay plate P (Step S4). Specifically, steps of attaching the diluent tip T2, sucking a predetermined amount of sample from the well U1, discharging the sample into the corresponding well P1 of the assay plate P and disposing the used tip are repeated for every well U1. Accordingly, each sample is further diluted.

Then, the assay plate P is sent to the temperature maintaining mechanism 50 by the stage mechanism 30. At the temperature maintaining mechanism 50, the assay plate P is kept at a preferable temperature by the heater 51. The assay plate P is shaken by the vibrating mechanism 80 in order to equalize the reaction of the reagent pre-applied in the assay plate P with each sample, or to stimulate the reaction. This shaking may take place outside the temperature maintaining mechanism 50 (Step S5) by transferring the assay plate P by the stage mechanism 30.

After heating with the temperature maintaining mechanism 50 for a predetermined period of time, each well P1 of the assay plate P is washed (Step S6). The wash bath 29 provided on the support frame 28 is transferred by the stage mechanism 30 and positioned immediately below the line of the nozzle pairs of the washing mechanism 60. The washing manifold 62 is descended from the set back level to the sucking level at once to connect the washing solution discharging nozzle 62a to the operating washing solution pressing pump and the sucking nozzle 62b to the operating suction pump. Accordingly, the washing solution is discharged into the wash bath 29 and sucked as the tip of the sucking nozzle 62b is washed. After a predetermined period of time, the washing solution discharging nozzle 62a is disconnected from the pump, and thereafter, the sucking nozzle 62b is disconnected from the pump. In this manner, the washing solution in the wash bath 29 is completely sucked. The washing manifold 62 returns to the set back level.

Next, the assay plate P is conveyed to the washing mechanism 60 by the stage mechanism 30. The wells P1 in the front-most row (in the proceeding direction) of the assay plate P are positioned immediately below the pairs of nozzles of the washing mechanism 60. Then, the washing manifold 62 is descended from the set back level to the sucking level to connect the sucking nozzles 62b to the suction pump under operation, thereby sucking the samples from the wells P1 in the front-most row. Then, the washing manifold 62 is ascended to the discharging level to discharge the washing solution from the washing solution discharging nozzles 62a. The washing manifold 62 is again descended to the sucking level to suck the washing solutions from the wells P1. After repeating these washing solution discharging and sucking steps for predetermined times, the washing manifold 62 returns to the set back level. The stage mechanism 30 sends the assay plate P to target the next row of wells to perform the same washing process. The washing operation is performed for every row, thereby washing all of the wells P1 of the assay plate P.

Although the sample in each well P1 is washed away by the washing operation, the sample has already soaked into the reagent pre-applied in each well P1 and thus no influence is caused upon the later-performed determination.

Next, a first reagent (an enzyme-labeled antibody solution) is dispensed into the wells P1 of the assay plate P (Step S7). This dispensing operation of the first reagent is performed in the similar manner to that for the diluent in Step S3. Specifically, the dispensing nozzle 45 is attached with a reagent tip T3 to suck the first reagent, aligned with the wells P1 to discharge the first reagent. Thereafter, the reagent tip T3 is disposed.

The assay plate P with the first reagent is shaken and heated in the same manner as Step S5 (Step S8). After keeping at a predetermined temperature for a predetermined period of time, the wells P1 are washed inside by the same operation as Step S6 (Step S9).

After washing the first reagent away, a second reagent (color developing substrate) is dispensed in generally the same manner as Step S7 (Step S10), followed by shaking and heating in the same manner as Step S8 (Step S11).

After keeping at a predetermined temperature for a predetermined period of time, a third reagent (stop solution) is dispensed into the wells P1 of the assay plate P in the same manner as Step S7 (Step S12).

Once the third reagent is dispensed, absorbance of each well P1 is determined for enzyme immunoreaction assay (Step S13). The absorbance is determined by the photometer 70. As a preparatory arrangement for the photometer 70, a light beam radiated from the halogen lamp 71a is received by the photodiode 72a under a condition where nothing is present between the radiation unit 71 and the sensor supporter 72, with the throughhole 73b being selected by the filter selecting means 74. The sensor output in this state is stored in the personal computer as a blank data for correcting the measurement data afterwards.

Next, wells P1 in the front-most row of the assay plate P in the proceeding direction are positioned between the radiation unit 71 and the sensor supporter 72 by the stage mechanism 30. The filter selecting means 74 selects the band pass filter 73a suitable for the measurement. The positioning means 79 positions the slider 78 such that the photodiode 72a stays immediately below the well P1 at the right end.

Then, the halogen lamp 71a is switched on and the light transmitted from the well P1 is detected by the photodiode 72a, thereby determining the absorbance. The positioning means 79 sends the slider 78 to the left for a single well P1 for determining the absorbance of the next well P1. After determining the absorbance for all of the wells P1 in the front-most row, the stage mechanism 30 conveys the assay plate P to the next row. By repeating these steps, absorbance is determined for all of the wells P1 of the assay plate P.

All of the results from the above-described measurement are stored in the personal computer, where the above-mentioned blank data is used for correction, thereby obtaining correct measurement results.

As described above, the reagent/sample tray 20, the stage mechanism 30 for conveying the reagent/sample tray 20, the dispensing mechanism 40 for dispensing the samples and the reagents, the temperature maintaining mechanism 50 for heating the assay plate P, the washing mechanism 60 for washing the wells P1, the photometer 70, and the vibrating mechanism 80 for shaking the assay plate P are assembled in a single device, the enzyme immunoreaction assaying apparatus 10. Therefore, a series of operations including the dispensing operations for a plurality of samples and reagents, and the heating, washing, shaking and reaction determining operations for the assay plate P can be automated, which has conventionally been considered difficult.

The assay plate P can be conveyed by the stage mechanism 30 to any one of the dispensing mechanism 40, the temperature maintaining mechanism 50, the washing mechanism 60 and the photometer 70 because the dispenser 41 of the above-described dispensing mechanism 40 can move reciprocally in a direction perpendicular to the reciprocating region of the reagent/sample tray 20 and because the temperature maintaining mechanism 50, the washing mechanism 60 and the photometer 70 are arranged on the reciprocating region of the reagent/sample tray 20 and are adjacent to the support frame 28 that is provided at the end of the reagent/sample tray 20. Thus, there is no need of providing individual conveying mechanisms for the reagent/sample tray 20 and for the assay plate P, thereby reducing the number of parts required for producing the apparatus. As a result, the productivity is enhanced, and the apparatus can be made smaller and lighter.

Since the conveyer 90 of the dispensing mechanism 40 transfers the dispenser 41 in the direction perpendicular to the reciprocating direction of the reagent/sample tray 20, the positioning of the dispensing nozzle 45 with respect to the reagent/sample tray 20 and the assay plate P can easily be calculated based on the rectangular coordinates system.

Furthermore, since the support frame 28 is protruding from the end of the reagent/sample tray 20 while the part of the housing 52 of the temperature mechanism 50 is notched where it overlaps with the translation region R of the assay plate/support frame, the assay plate P and the support frame 28 can be conveyed inside the housing 52 of the temperature maintaining mechanism 50 upon transferring the reagent/sample tray 20. Thus, for the temperature maintaining operation, there is no need of providing individual mechanisms for placing and removing the assay plate P in and from the temperature maintaining mechanism 50, thereby reducing the number of parts required for producing the apparatus. As a result, the productivity is enhanced, and the apparatus can be made smaller and lighter.

In the enzyme immunoassaying apparatus 10, the vibrating mechanism 80 for shaking the assay plate P via the support frame 28 is provided on the reagent/sample tray 20. Accordingly, there is no need of providing an independent conveying means for conveying the assay plate P to the vibrating mechanism 80, thereby reducing the number of parts required for producing the apparatus. As a result, the productivity is enhanced, and the apparatus can be made smaller and lighter.

Moreover, the support frame 28 is provided with the hollows 28a and 28b for arranging the assay plate P and the dilution plate U therein, respectively. Accordingly, dilution to a lower concentration can be performed on the dilution plate U followed by further dilution on the assay plate P. The assay plate P and the dilution plate U can be shaken at the same time via the support frame 28, thereby reducing the time required for the operations. Since there is no need of providing an independent vibrating mechanism for the dilution plate U, the number of parts required for producing the apparatus can be reduced. As a result, the productivity is enhanced, and the apparatus can be made smaller and lighter.

The invention of claim 1 comprises: a tray conveying mechanism for conveying a sample/reagent tray; a dispensing mechanism for dispensing a sample or a regent into a microplate having a plurality of reaction wells; and a temperature maintaining mechanism for the microplate. As a result, a sample assaying apparatus is provided which can automatically perform a plurality of operations including dispensing a plurality of samples and reagents into a microplate, and heating the microplate.

The microplate can be conveyed by the tray conveying mechanism to either one of the dispensing mechanism and the temperature maintaining mechanism because the dispenser of the dispensing mechanism can move reciprocally in a direction perpendicular to the reciprocating region of the reagent/sample tray and because the temperature maintaining mechanism is arranged on the reciprocating region of the reagent/sample tray and is adjacent to the microplate supporter that is provided at the end of the reagent/sample tray. Thus, there is no need of providing individual conveying mechanisms for the reagent/sample tray and for the microplate, thereby reducing the number of parts required for producing the apparatus. As a result, the productivity is enhanced, and the apparatus can be made smaller and lighter.

According to claim 2 of the invention, the conveyer of the dispensing mechanism transfers the dispenser in the direction perpendicular to the reciprocating direction of the reagent/sample tray. Thus, the positioning of the dispenser with respect to the reagent/sample tray and the microplate can easily be calculated based on the rectangular coordinates system.

According to the invention of claim 3, a sample assaying apparatus can be provided which can carry out a washing operation in addition to the above-mentioned operations by further comprising a washing mechanism for washing the microplate, wherein the washing mechanism is arranged adjacent to the microplate-supporter side of the reciprocating region of the reagent/sample tray. Since the microplate can be sent to the washing mechanism by transferring the reagent/sample tray, there is no need of providing an independent conveying mechanism for conveying the microplate to the washing mechanism, thereby reducing the number of parts required for producing the apparatus. As a result, the productivity is enhanced, and the apparatus can be made smaller and lighter.

According to the invention of claim 4, a sample assaying apparatus can be provided which can carry out a reaction determining operation in addition to the above-mentioned operations by further comprising a photometer arranged adjacent to the microplate-supporter side of the reciprocating region of the reagent/sample tray. Since the microplate can be sent to the photometer by transferring the reagent/sample tray, there is no need of providing an independent conveying mechanism for conveying the microplate to the photometer, thereby reducing the number of parts required for producing the apparatus. As a result, the productivity is enhanced, and the apparatus can be made smaller and lighter.

According to the invention of claim 5, the microplate supporter is protruding from the end of the reagent/sample tray while the part of the housing of the temperature mechanism is notched where it overlaps with the translation region of the microplate/supporter. Thus, the microplate and the supporter can be conveyed inside the housing of the temperature maintaining mechanism by transferring the reagent/sample tray. Accordingly, for the temperature maintaining operation, there is no need of providing individual mechanisms for placing and removing the microplate in and from the temperature maintaining mechanism, thereby reducing the number of parts required for producing the apparatus. As a result, the productivity is enhanced, and the apparatus can be made smaller and lighter.

According to the invention of claim 6, the microplate supporter is formed as a frame so as to hold the microplate with the top and back surfaces thereof being exposed. At the same time, the temperature adjuster of the temperature maintaining mechanism is provided beneath the microplate while a lid is provided above the microplate. Thus, the temperature of the microplate can efficiently be adjusted from the exposed back surface of the microplate while the moisture contained in the reaction vessels can be prevented from evaporating upon the temperature adjustment.

According to the invention of claim 7, a sample assaying apparatus is provided which can carry out an shaking operation in addition to the above-mentioned operations by further comprising a vibrating mechanism for shaking the microplate via the supporter on the reagent/sample tray. Since the vibrating mechanism shakes the microplate via the supporter, there is no need of providing an independent conveying means for conveying the microplate to the vibrating mechanism, thereby reducing the number of parts required for producing the apparatus. As a result, the productivity is enhanced, and the apparatus can be made smaller and lighter.

According to the invention of claim 8, the supporter is provided with regions for arranging the microplate and a dilution plate therein. Accordingly, dilution to a lower concentration can be performed on the dilution plate followed by further dilution on the microplate. In addition, the microplate and the dilution plate can be shaken at the same time via the supporter, thereby reducing the time required for the operations. Since there is no need of providing an independent vibrating mechanism for the dilution plate, the number of parts required for producing the apparatus can be reduced. As a result, the productivity is enhanced, and the apparatus can be made smaller and lighter.

As described above, the present invention provides a sample assaying apparatus, which is superior over conventional apparatuss.

The invention may be embodied in other specific forms without departing from the spirit or essential characteristic thereof. The present embodiments are therefore to be considered in all respects as illustrative and not restrictive, the scope of the invention being indicated by the appended claims rather than by the foregoing description and all changes which come within the meaning and range of equivalency of the claims are therefore intended to be embraced therein.

The entire disclosure of Japanese Patent Application No. 2000-212363 (Filed on Jul. 13, 2000) including specification, claims, drawings and summary are incorporated herein by reference in its entirety.

What is to be claimed:

1. A sample assaying apparatus for performing a reaction assay for a sample by using a microplate having a plurality of reaction vessels thereon in which the sample and a reagent are subjected to reaction, the apparatus comprising:
a reagent/sample tray for mounting a plurality of containers individually containing the reagent or the sample;
a base for supporting the reagent/sample tray such that the tray is capable of moving reciprocally;
a tray conveying mechanism for conveying the reagent/sample tray reciprocally;
a dispensing mechanism for dispensing the sample or the reagent into each reaction vessel of the microplate; and
a temperature maintaining mechanism for maintaining the temperature of the microplate at a predetermined temperature,
wherein the dispensing mechanism has a dispenser for dispensing the sample or the reagent and a conveyer for conveying the dispenser in a direction perpendicular to the reciprocating direction of the reagent/sample tray; a supporter for the microplate is provided at the end of the direction perpendicular to the reciprocating direction of the reagent/sample tray; and the temperature maintaining mechanism is arranged adjacent to the supporter-provided side of the reciprocating region of the reagent/sample tray.

2. A sample assaying apparatus according to claim 1, wherein the conveyer of the dispensing mechanism conveys the dispenser in a direction perpendicular to the reciprocating direction of the reagent/sample tray.

3. A sample assaying apparatus according to claim 1, further comprising a washing mechanism for washing inside each of the reaction vessels of the microplate, wherein the washing mechanism is arranged adjacent to the supporter-provided side of the reciprocating region of the reagent/sample tray.

4. A sample assaying apparatus according to claim 3, further comprising a photometer for determining the reaction within each of the reaction vessels of the microplate, wherein the photometer is arranged adjacent to the supporter-provided side of the reciprocating region of the reagent/sample tray.

5. A sample assaying apparatus according to claim 1, wherein the supporter of the microplate is protruding from the end of the reagent/sample tray in the direction perpendicular to the reciprocating direction of the reagent/sample tray; the temperature maintaining mechanism has a temperature adjuster and a housing for accommodating the temperature adjuster and is arranged to overlap the translation region of the microplate and the supporter; and the housing is provided with a notch where it overlaps with the translation region of the microplate and the supporter.

6. A sample assaying apparatus according to claim 5, wherein the supporter of the microplate is formed as a frame so as to hold the microplate with the top and back surfaces thereof being exposed; the temperature adjuster of the temperature maintaining mechanism faces the back surface of the microplate held by the supporter; and the housing has a lid for covering the top surface of the microplate.

7. A sample assaying apparatus according to claim 1, further comprising a vibrating mechanism on the reagent/sample tray for shaking the microplate via the supporter.

8. A sample assaying apparatus according to claim 7, wherein the supporter is provided with regions for arranging the microplate for reacting the sample and the reagent and for arranging a microplate for performing dilution.
